(19) United States
(12) Patent Application Publication
(10) Pub. No.: US 2025/0308068 A1
(43) Pub. Date: Oct. 2, 2025

(54) SYSTEM AND METHOD FOR FIELD CALIBRATION OF A VISION SYSTEM

(71) Applicant: COGNEX CORPORATION, Natick, MA (US)

(72) Inventors: Caitlin WURZ, Natick, MA (US); Humberto Andres Leon LIU, Natick, MA (US); Patrick BRODEUR, Natick, MA (US); Georges GAUTHIER, Cambridge, MA (US); Kyle SPOSATO, Natick, MA (US); Michael CORBETT, Natick, MA (US); Ahmed EL-BARKOUKY, Hopkinton, MA (US)

(21) Appl. No.: 18/864,217

(22) PCT Filed: May 9, 2023
(86) PCT No.: PCT/US2023/066778

§ 371 Date: Nov. 8, 2024

Related U.S. Application Data
(60) Provisional application No. 63/339,891, filed on May 9, 2022.

(51) Int. Cl. G06T 7/80; G06T 7/73; H04N 17/00; H04N 23/90

(52) U.S. Cl. CPC G06T 7/80; G06T 7/73; H04N 17/002; H04N 23/90; G06T 2200/24

(57) ABSTRACT

A method for three-dimensional (3D) field calibration of a machine vision system includes receiving a set of calibration parameters and an identification of one or more machine vision system imaging devices, determining a camera acquisition parameter for calibration based on the set of calibration parameters, validating the set of calibration parameters and the camera acquisition parameter, and controlling the imaging device(s) to collect image data of a calibration target. The image data may be collected using the determined camera acquisition parameter. The method further includes generating a set of calibration data for the imaging device(s) using the collected image data for the imaging device(s). The set of calibration data can include a maximum error. The method further includes generating a report including the set of calibration data for the imaging device(s) and an indication of whether the maximum error for the imaging device(s) is within an acceptable tolerance and displaying the report on a display.

### CROSS-REFERENCE TO RELATED APPLICATIONS

This application is based on, claims priority to, and incorporates herein by reference in its entirety Ser. No. 63/339,891 filed May 9, 2022 and entitled “System and Method for Field Calibration of a Vision System.”

### STATEMENT REGARDING FEDERALLY SPONSORED RESEARCH

N/A

### BACKGROUND

The present technology relates to imaging systems, including machine vision systems that are configured to acquire and analyze images of objects or symbols (e.g., barcodes).

Machine vision systems are generally configured for use in capturing images of objects or symbols and analyzing the images to identify the objects or decode the symbols. Accordingly, machine vision systems generally include one or more devices for image acquisition and image processing. In conventional applications, these devices can be used to acquire images, or to analyze acquired images, such as for the purpose of decoding imaged symbols such as barcodes or text. In some contexts, machine vision and other imaging systems can be used to acquire images of objects that may be larger than a field of view (FOV) for a corresponding imaging device and/or that may be moving relative to an imaging device.

### SUMMARY

In accordance with an embodiment of the technology, a method for three dimensional field calibration of a machine vision system includes receiving a set of calibration parameters and an identification of at least one imaging device of the machine vision system, determining a camera acquisition parameter for calibration based on the set of calibration parameters, validating the set of calibration parameters and the camera acquisition parameter, and controlling the at least one imaging device to collect image data of a calibration target. The image data may be collected using the determined camera acquisition parameter. The method further includes generating a set of calibration data for the at least one imaging device using the collected image data. The set of calibration data can include a maximum error. The method further includes generating a report including the set of calibration data for the at least one imaging device and an indication of whether the maximum error for the at least one imaging device is within an acceptable tolerance.

In some embodiments, the method further includes displaying the report using a display. In some embodiments, the machine vision system is configured as a tunnel comprising one imaging device. In some embodiments, the machine vision system is configured as a tunnel comprising a plurality of imaging devices. In some embodiments, the set of calibration data includes one or more of a runtime conveyor speed, a calibration conveyor speed, a connection address associated with the at least one imaging device, a type of calibration target, or a set of dimensions for the calibration target. In some embodiments, the method further includes before controlling the at least one imaging device to collect image data of a calibration target, storing, a set of customer system settings for the at least one imaging device. In some embodiments, the method further includes loading the set of calibration data on the at least one imaging device. In some embodiments, generating an indication of whether the maximum error is within an acceptable tolerance includes comparing the maximum error to at least one predetermined error threshold. In some embodiments, the report further includes an image generated based on the collected image data. In some embodiments, the calibration target comprises a symbol and the maximum error is a difference between an actual symbol center location and a calculated symbol center location.

In accordance with another embodiment of the technology, a system for three dimensional field calibration of a machine vision system includes an input configured to receive a set of calibration parameters and an identification of at least one imaging device of the machine vision system and at least one processor device coupled to the input. The at least one processor device may be configured to determine a camera acquisition parameter for calibration based on the set of calibration parameters, validate the set of calibration parameters and the camera acquisition parameter, control the at least one imaging device to collect image data of a calibration target, wherein the image data is collected using the determined camera acquisition parameter, generate a set of calibration data for the at least one imaging device using the collected image data, wherein the set of calibration data includes a maximum error, and generate a report including the set of calibration data for the at least one imaging device and an indication of whether the maximum error for the at least one imaging device is within an acceptable tolerance.

In some embodiments, the system can further include a display coupled to the at least one processor device and configured to display the report. In some embodiments, the set of calibration data includes one or more of a runtime conveyor speed, a calibration conveyor speed, a connection address associated with the at least one imaging device, a type of calibration target, or a set of dimensions for the calibration target. In some embodiments, the at least one processor device is further configured to, before controlling the at least one imaging device to collect image data of a calibration target, store a set of customer system settings for the at least one imaging device. In some embodiments, the at least one processor device is further configured to generate a graphical user interface. In some embodiments, generating an indication of whether the maximum error for the at least one imaging device is within an acceptable tolerance includes comparing the maximum error to at least one predetermined error threshold. In some embodiments, the machine vision system is configured as a tunnel comprising one imaging device. In some embodiments, the machine vision system is configured as a tunnel comprising a plurality of imaging devices. In some embodiments, the report further includes an image generated based on the collected image data. In some embodiments, the calibration target comprises a symbol and the maximum error is a difference between an actual symbol center location and a calculated symbol center location.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1A shows an example of a system for capturing multiple images of each side of an object in accordance with an embodiment of the technology;

FIG. 1B shows an example of a system for capturing multiple images of each side of an object in accordance with an embodiment of the technology;

FIG. 2 shows another example of a system for capturing multiple images of each side of an object in accordance with an embodiment of the technology;

FIG. 3 shows another example system for capturing multiple images of each side of an object in accordance with an embodiment of the technology;

FIG. 4 shows a system for three-dimensional field calibration of a machine vision system accordance with an embodiment of the technology;

FIG. 5 shows an example of a server in the system shown in FIG. 4 in accordance with an embodiment of the technology;

FIG. 6 illustrates a method for three-dimensional field calibration of a machine vision system in accordance with an embodiment of the technology;

FIGS. 7A-7D illustrate an example setup user interface in accordance with an embodiment of the technology;

FIG. 8 illustrates an example validation (prior to calibration) user interface in accordance with an embodiment of the technology;

FIGS. 9A and 9B illustrate an example data collection user interface in accordance with an embodiment of the technology;

FIGS. 10A-10D illustrate an example calibration user interface in accordance with an embodiment of the technology;

FIG. 11 illustrates an example finalization user interface in accordance with an embodiment of the technology;

FIG. 12A shows an example of a factory calibration setup that can be used to find a transformation between an image coordinate space and a calibration target coordinate space;

FIG. 12B shows an example of coordinate spaces for a field calibration process and associated with various portions of a system for capturing multiple images of each side of an object and for three-dimensional field calibration of a machine vision system in accordance with an embodiment of the technology;

FIG. 12C shows an example of a field calibration process for generating an imaging device model useable to transform coordinates of an object in a 3D coordinate space associated with the system for capturing multiple images of each side of the object into coordinates in a 2D coordinate space associated with the imaging device in accordance with an embodiment of the technology;

FIG. 13A shows an example of correspondence between coordinates of an object in the 3D coordinate space associated with the system for capturing multiple images of each side of the object and coordinates of the object in the 2D coordinate space associated with the imaging device;

FIG. 13B shows another example of correspondence between coordinates of the object in the 3D coordinate space and coordinates of the object in the 2D coordinate space; and

FIGS. 14A and 14B illustrate an example user interface with an abort calibration option in accordance with an embodiment of the technology.

### DETAILED DESCRIPTION

Machine vision systems can include one or more imaging devices. For example, in some embodiments, a machine vision system may be implemented in a tunnel arrangement (or system) which can include a structure on which each of the imaging devices can be positioned at an angle relative to a conveyor resulting in an angled FOV. As used herein, “machine vision tunnel” (or simply “tunnel” or “tunnel system”) may refer to a system that includes and supports one or more imaging devices to acquire image data relative to a common scene. In some embodiments, the common scene can include a relatively small area such as, for example, a tabletop or a discrete section of a conveyor. In some embodiments, within a given tunnel system there may be overlap between the FOVs of imaging devices, no overlap between FOVs of imaging devices, or a combination thereof (e.g., overlap between certain sets of imaging devices but not between others, collective overlap of multiple imaging devices to cover an entire scene, etc.).

Deployment of a machine vision system. e.g., a tunnel system, at a customer site can involve a number of steps including installation, commissioning, field calibration and testing. Customized machine vision systems can require a complicated and lengthy installation and setup and require a large number of resources. It would be advantageous to provide systems and applications that can simplify and streamline deployment of a machine vision system. For example, modular hardware elements (e.g., prebuilt modules) can be configured to implement system configurations and specifications and can reduce installation time. The present disclosure describes systems and methods configured for simplifying the deployment process including a three-dimensional (3D) field calibration process for a machine vision system. In some embodiments, the systems and methods for field calibration can include integrated hardware and software elements including applications that can automate one or more portions of the 3D field calibration process. Advantageously, the disclosed 3D system for field calibration can provide a standardized field calibration interface that can provide repeatability from system to system and customer to customer. The disclosed system and method for 3D field calibration can also reduce the time (and therefore the amount of required downtime) and resources necessary to install a machine vision system and therefore, improve efficiency of deployment of the machine vision system. In addition, the disclosed system and method for 3D calibration can reduce the number of trained personnel required to support and maintain an installed machine vision system. While the following description refers to a tunnel system or arrangement, it should be understood that the systems and methods for 3D field calibration described herein may be applied to other types of machine vision system arrangements.

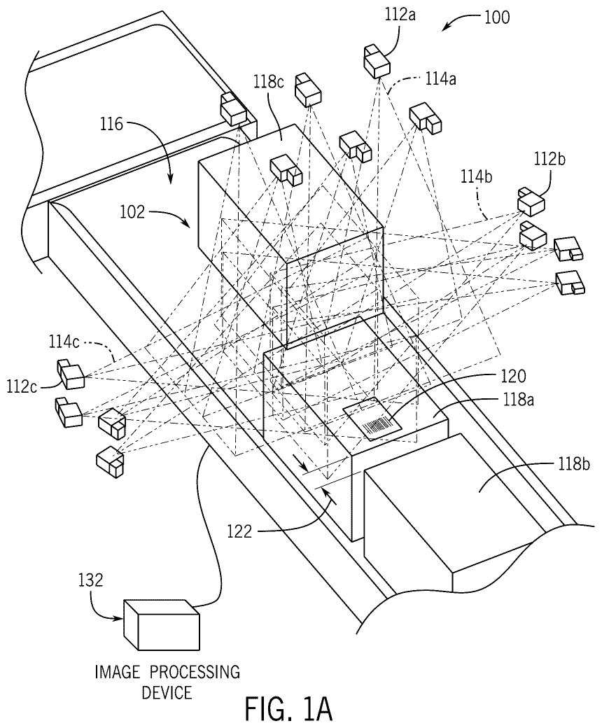

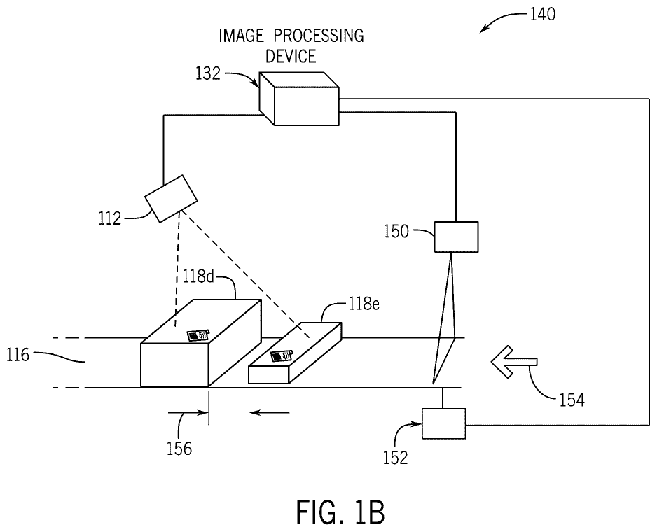

FIG. 1A shows an example of a system 100 for capturing multiple images of each side of an object in accordance with an embodiment of the technology. In some embodiments, system 100 can be configured to evaluate symbols (e.g., barcodes, two-dimensional (2D) codes, fiducials, hazmat, machine readable code, alpha-numeric codes, and other labels.) on objects (e.g., objects 118a, 118b) moving through a tunnel 102, such as a symbol 120 on object 118a. In some embodiments, symbol 120 is a flat barcode on a top surface of object 118a, and objects 118a and 118b are roughly cuboid boxes. Additionally or alternatively, in some embodiments, any suitable geometries are possible for an object to be imaged, and any variety of symbols and symbol locations can be imaged and evaluated, including non-direct part mark (DPM) symbols and DPM symbols located on a top or any other side of an object. Alternatively, or in addition, in some embodiments, a non-symbol recognition approach may be implemented. As one example, some implementations can include a vision-based recognition of non-symbol based features, such as, e.g., one or more edges of the object.

In FIG. 1A, objects 118a and 118b are disposed on a conveyor 116 that is configured to move objects 118a and 118b in a direction of travel (e.g., horizontally left-to-right) through tunnel 102 at a relatively predictable and continuous rate, or at a variable rate measured by a device, such as an encoder or other motion measurement device. Additionally or alternatively, objects can be moved through tunnel 102 in other ways (e.g., with non-linear movement). In some embodiments, conveyor 116 can include a conveyor belt. In some embodiments, conveyor 116 can consist of other types of transport systems.

In some embodiments, system 100 can include one or more imaging devices 112 and an image processing device 132. For example, system 100 can include multiple imaging devices in a tunnel arrangement (e.g., implementing a portion of tunnel 102), representatively shown via imaging devices 112a, 112b, and 112c, each with a field-of-view (“FOV”), representatively shown via FOV 114a, 114b, 114c, that includes part of the conveyor 116. In some embodiments, each imaging device 112 can be positioned at an angle relative to the conveyor top or side (e.g., at an angle relative to a normal direction of symbols on the sides of the objects 118a and 118b or relative to the direction of travel), resulting in an angled FOV. Similarly, some of the FOVs can overlap with other FOVs (e.g., FOV 114a and FOV 114b). In such embodiments, system 100 can be configured to capture one or more images of multiple sides of objects 118a and/or 118b as the objects are moved by conveyor 116. In some embodiments, the captured images can be used to identify symbols on each object (e.g., a symbol 120), which can be subsequently decoded (as appropriate). In some embodiments, a gap in conveyor 116 (not shown) can facilitate imaging of a bottom side of an object (e.g., as described in U.S. Patent Application Publication No. 2019/0333259, filed on Apr. 25, 2018, which is hereby incorporated by reference herein in its entirety) using an imaging device or array of imaging devices (not shown), disposed below conveyor 116). In some embodiments, the captured images from a bottom side of the object may also be used to identify symbols on the object, which can be subsequently decoded (as appropriate).

Note that although two arrays of three imaging devices 112 are shown imaging a top of objects 118a and 118b, and four arrays of two imaging devices 112 are shown imaging sides of objects 118a and 118b, this is merely an example, and any suitable number of imaging devices can be used to capture images of various sides of objects. For example, each array can include four or more imaging devices. In some cases, the system 100 may include a smaller number of imaging devices 112 than shown in FIG. 1A or a greater number of imaging devices 112. For example, as discussed above a tunnel system may include only one imaging device 112. In some cases, the single imaging device 112 may be positioned to image a top of objects 118a and 118b, to image a side of objects 118a and 118b, or may be positioned to image a bottom of objects 118a and 118b. In another example, various combinations of two or more imaging devices 112 (e.g., various combinations of imaging devices 112a, 112b and 112c) may be included in the system 100. In some cases, one imaging device 112a may be positioned to image a top of objects 118a and 118b and one imaging device 112b may be positioned to image a side of objects 118a and 118b. In other cases, one imaging device 112a may be positioned to image a top of objects 118a and 118b and one imaging device 112c may be positioned to image a side of objects 118a and 118b.

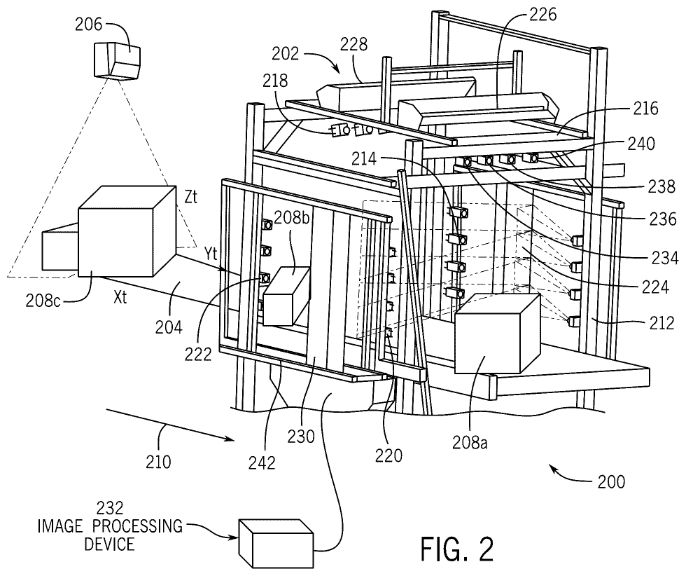

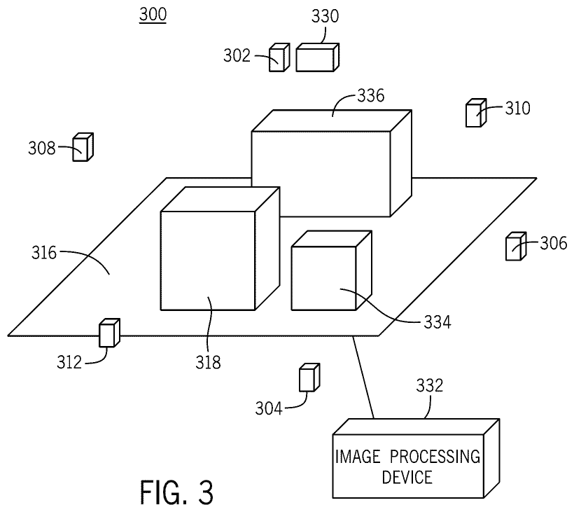

Although imaging devices 112 are generally shown imaging objects 118a and 118b without mirrors to redirect a FOV, this is merely an example, and one or more fixed and/or steerable mirrors can be used to redirect a FOV of one or more of the imaging devices as described below with respect to FIGS. 2 and 3, which may facilitate a reduced vertical or lateral distance between imaging devices and objects in tunnel 102. For example, imaging device 112a can be disposed with an optical axis parallel to conveyor 116, and one or more mirrors can be disposed above tunnel 102 to redirect a FOV from imaging devices 112a toward a front and top of objects in tunnel 102.

In some embodiments, imaging devices 112 can be implemented using any suitable type of imaging device(s). For example, imaging devices 112 can be implemented using 2D imaging devices (e.g., 2D cameras), such as area scan cameras and/or line scan cameras. In some embodiments, imaging device 112 can be an integrated system that includes a lens assembly and an imager, such as a CCD or CMOS sensor. In some embodiments, imaging devices 112 may each include one or more image sensors, at least one lens arrangement, and at least one control device (e.g., a processor device) configured to execute computational operations relative to the image sensor. Each of the imaging devices 112a, 112b, or 112c can selectively acquire image data from different fields of view (FOVs), regions of interest (“ROIs”), or a combination thereof. In some embodiments, system 100 can be utilized to acquire multiple images of each side of an object where one or more images may include more than one object. Object 118 may be associated with one or more symbols, such as a barcode, a QR code, etc. In some embodiments, system 100 can be configured to facilitate imaging of the bottom side of an object supported by conveyor 116 (e.g., the side of object 118a resting on conveyor 116). For example, conveyor 116 may be implemented with a gap, such as a gap between sections of the conveyor 116 (as also discussed above).

In some embodiments, a gap 122 is provided between objects 118a, 118b. In different implementations, gaps between objects can range in size. In some implementations, gaps between objects can be substantially the same between all sets of objects in a system, or can exhibit a fixed minimum size for all sets of objects in a system. In some embodiments, smaller gap sizes may be used to maximize system throughput.

In some embodiments, system 100 can include a dimensioning system (not shown), sometime referred to herein as a dimensioner, that can measure dimensions of objects moving toward tunnel 102 on conveyor 116. Additionally, system 100 can include devices (e.g., an encoder or other motion measurement device, not shown) to track the physical movement of objects (e.g., objects 118a, 118b) moving through the tunnel 102 on the conveyor 116. FIG. 1B shows an example of a system for capturing multiple images of each side of an object in accordance with an embodiment of the technology. FIG. 1B shows a simplified diagram of a system 140 to illustrate an example arrangement of a dimensioner and a motion measurement device (e.g., an encoder) with respect to a tunnel. As mentioned above, the system 140 may include a dimensioner 150 and a motion measurement device 152. In the illustrated example, a conveyor 116 is configured to move objects 118d, 118e along the direction indicated by arrow 154 past a dimensioner 150 before the objects 118d, 118e are imaged by one or more imaging devices 112. In the illustrated embodiment, a gap 156 is provided between objects 118d and 118e and an image processing device 132 may be in communication with the one or more imaging devices 112, dimensioner 150 and motion measurement device 152. Dimensioner 150 can be configured to determine dimensions and/or a location of an object supported by support structure 116 (e.g., object 118d or 118e) at a certain point in time. For example, dimensioner 150 can be configured to determine a distance from dimensioner 150 to a top surface of the object, and can be configured to determine a size and/or orientation of a surface facing dimensioner 150. In some embodiments, dimensioner 150 can be implemented using various technologies. For example, dimensioner 150 can be implemented using a 3D camera (e.g., a structured light 3D camera, a continuous time of flight 3D camera, etc.). As another example, dimensioner 150 can be implemented using a laser scanning system (e.g., a LiDAR system). In a particular example, dimensioner 150 can be implemented using a 3D-A1000 system available from Cognex Corporation. In some embodiments, the dimensioning system or dimensioner 150 (e.g., a time-of-flight sensor or computed from stereo) may be implemented in a single device or enclosure with an imaging device (e.g., a 2D camera) and, in in some embodiments, a processor (e.g., that may be utilized as the image processing device) may also be implemented in the device with the dimensioner and imaging device.

In some embodiments, dimensioner 150 can determine 3D coordinates of each corner of the object in a coordinate space defined with reference to one or more portions of system 140. For example, dimensioner 150 can determine 3D coordinates of each of eight corners of an object that is at least roughly cuboid in shape within a Cartesian coordinate space defined with an origin at dimensioner 150. As another example, dimensioner 150 can determine 3D coordinates of each of eight corners of an object that is at least roughly cuboid in shape within a Cartesian coordinate space defined with an origin at the dimensioner 150. As another example, dimensioner 150 can determine 3D coordinates of each of eight corners of an object that is at least roughly cuboid in shape within a Cartesian coordinate space defined with respect to conveyor 116 (e.g., with an origin that originates at a center of conveyor 116).

In some embodiments, a motion measurement device 152 (e.g., an encoder) may be linked to the conveyor 116 and imaging devices 112 to provide electronic signals to the imaging devices 112 and/or image processing device 132 that indicate the amount of travel of the conveyor 116, and the objects 118d, 118e supported thereon, over a known amount of time. This may be useful, for example, in order to coordinate capture of images of particular objects (e.g., objects 118d, 118c), based on calculated locations of the object relative to a field of view of a relevant imaging device (e.g., imaging device(s) 112). In some embodiments, motion measurement device 152 may be configured to generate a pulse count (e.g., an encoder pulse count) that can be used to identify the position of conveyor 116 along the direction of travel (e.g., the direction of the arrow 154). For example, motion measurement device 152 may provide the pulse count (e.g., an encoder pulse count) to image processing device 132 for identifying and tracking the positions of objects (e.g., objects 118d, 118e) on conveyor 116. In some embodiments, the motion measurement device 152 can increment a pulse count (e.g., an encoder pulse count) each time conveyor 116 moves a predetermined distance (encoder pulse count distance) in the direction of arrow 154. In some embodiments, an object's position can be determined based on an initial position, the change in the pulse count, and the pulse count distance.

As mentioned above, a tunnel system can include and support one or more imaging devices to acquire image data relative to a common scene. In some embodiments, the tunnel system can include one imaging device, for example, in FIG. 1B in some embodiments, imaging device 112 may represent a single imaging device. While imaging device 112 is shown in a position at the top of the system 140 above the conveyor, in some cases, the imaging device 112 may be positioned on the side of the system 140 or may be positioned below the system 140 (e.g., below a gap in the conveyor 116.

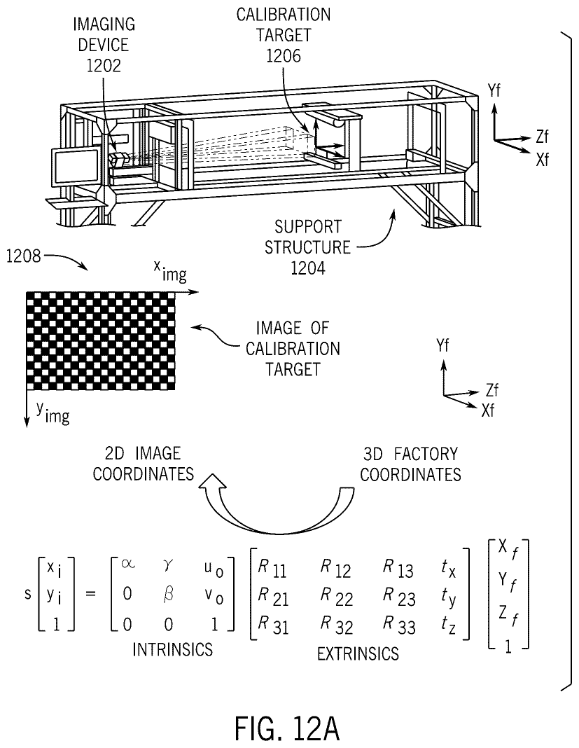

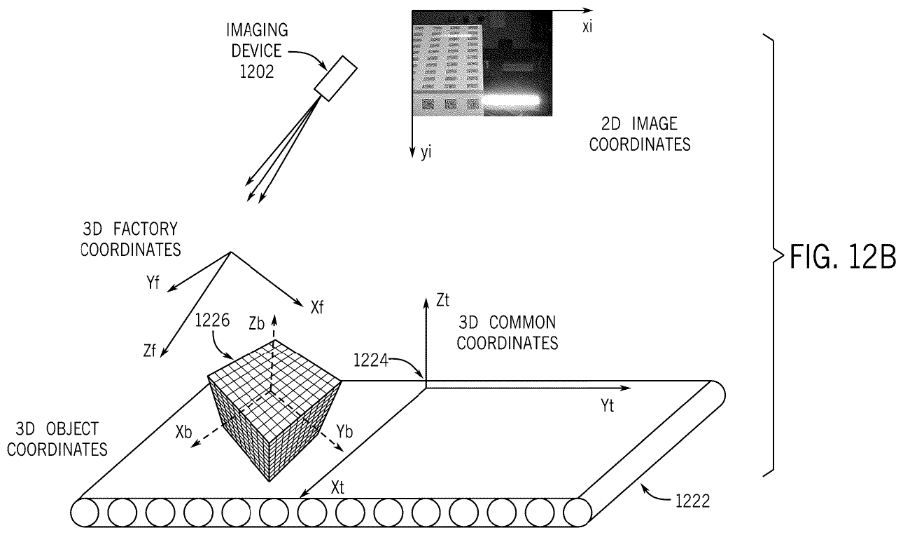

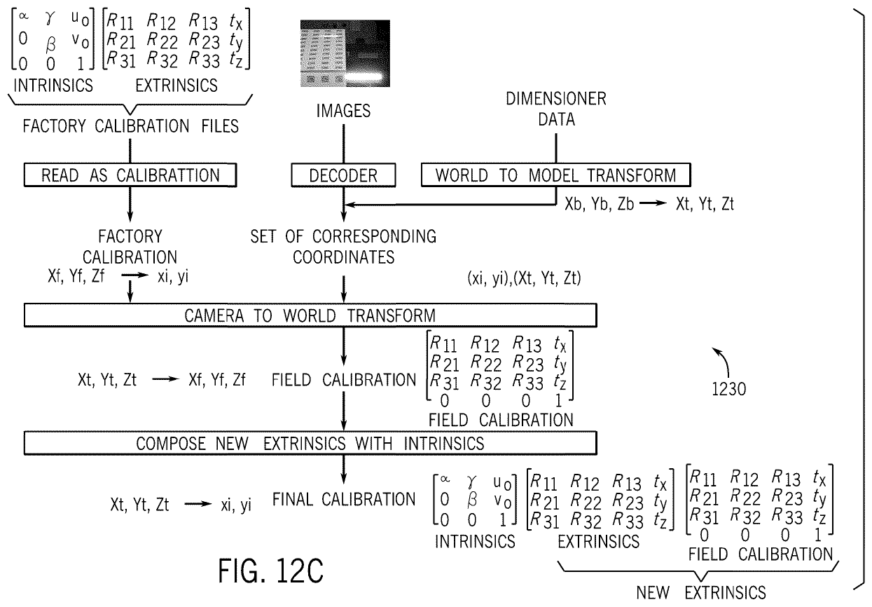

Returning to FIG. 1A, in some embodiments, each imaging device (e.g., imaging devices 112) can be calibrated (e.g., as described below in connection with FIGS. 12A to 12C) to facilitate mapping a 3D location of each corner of an object supported by conveyor 116 (e.g., objects 118) to a 2D location in an image captured by the imaging device.

In some embodiments, image processing device 132 (or a control device) can coordinate operations of various components of system 100 (or system 140). For example, image processing device 132 can cause a dimensioner (e.g., dimensioner 150 shown in FIG. 1B) to acquire dimensions of an object positioned on conveyor 116 and can cause imaging devices 112 to capture images of each side. In some embodiments, image processing device 132 can control detailed operations of each imaging device, for example, by providing trigger signals to cause the imaging device to capture images at particular times, etc. Alternatively, in some embodiments, another device (e.g., a processor included in each imaging device, a separate controller device, etc.) can control detailed operations of each imaging device. For example, image processing device 132 (and/or any other suitable device) can provide a trigger signal to each imaging device and/or dimensioner (e.g., dimensioner 150 shown in FIG. 1B), and a processor of each imaging device can be configured to implement a predesignated image acquisition sequence that spans a predetermined region of interest in response to the trigger. Note that system 100 can also include one or more light sources (not shown) to illuminate surfaces of an object, and operation of such light sources can also be coordinated by a central device (e.g., image processing device 132), and/or control can be decentralized (e.g., an imaging device can control operation of one or more light sources, a processor associated with one or more light sources can control operation of the light sources, etc.). For example, in some embodiments, system 100 can be configured to concurrently (e.g., at the same time or over a common time interval) acquire images of multiple sides of an object, including as part of a single trigger event. For example, each imaging device 112 can be configured to acquire a respective set of one or more images over a common time interval. Additionally or alternatively, in some embodiments, imaging devices 112 can be configured to acquire the images based on a single trigger event. For example, based on a sensor (e.g., a contact sensor, a presence sensor, an imaging device, etc.) determining that object 118 has passed into the FOV of the imaging devices 112, imaging devices 112 can concurrently acquire images of the respective sides of object 118.

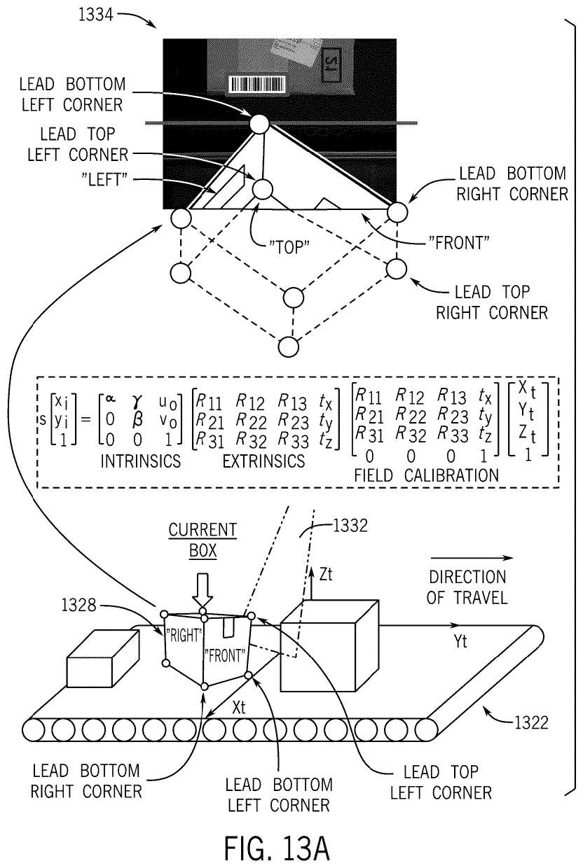

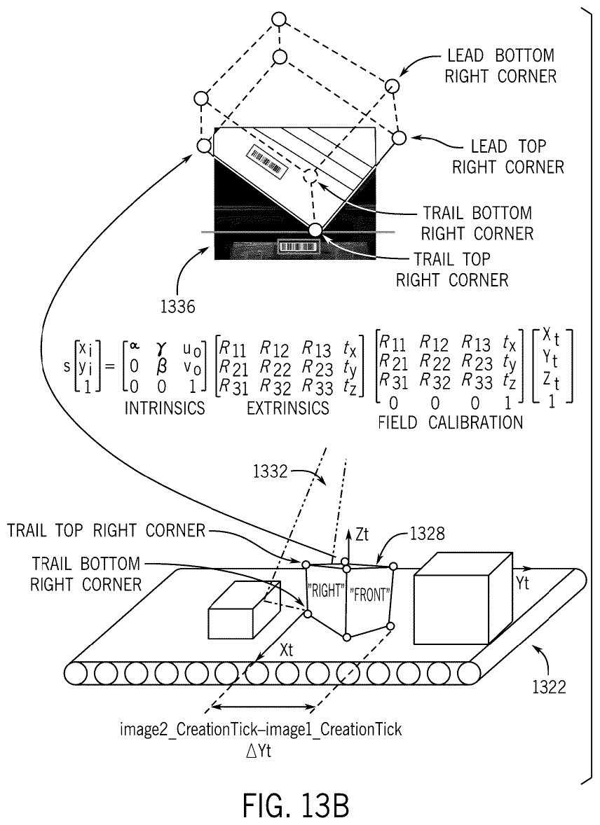

In some embodiments, each imaging device 112 can generate an image set depicting a FOV or various FOVs of a particular side or sides of an object supported by conveyor 116 (e.g., object 118). In some embodiments, image processing device 132 can map 3D locations of one or more corners of object 118 to a 2D location within each image in set of images output by each imaging device (e.g., as described below in connection with FIGS. 13A and 13B, which show multiple boxes on a conveyor). In some embodiments, image processing device can generate a mask that identifies which portion of an image is associated with each side (e.g., a bit mask with a 1 indicating the presence of a particular side, and a 0 indicating an absence of a particular side) based on the 2D location of each corner. In some embodiments, the 3D locations of one or more corners of a target object (e.g., object 118a) as well as the 3D locations of one or more corners of an object 118c (a leading object) ahead of the target object 118a on the conveyor 116 and/or the 3D locations of one or more corners of an object 118b (a trailing object) behind the target object 118a on the conveyor 116 may be mapped to a 2D location within each image in the set of images output by each imaging device. Accordingly, if an image captures more than one object (118a, 118b, 118c), one or more corners of each object in the image may be mapped to the 2D image.

As mentioned above, one or more fixed and/or stecrable mirrors can be used to redirect a FOV of one or more of the imaging devices, which may facilitate a reduced vertical or lateral distance between imaging devices and objects in tunnel 102. FIG. 2 shows another example of a system for capturing multiple images of each side of an object in accordance with an embodiment of the technology. System 200 includes multiple banks of imaging devices 212, 214, 216, 218, 220, 222 and multiple mirrors 224, 226, 228, 230 in a tunnel arrangement 202. For example, the banks of imaging devices shown in FIG. 2 include a left trail bank 212, a left lead bank 214, a top trail bank 216, a top lead bank 218, a right trail bank 220 and a right lead bank 222. In the illustrated embodiment, each bank 212, 214, 216, 218, 220, 222 includes four imaging devices that are configured to capture images of one or more sides of an object (e.g., object 208a) and various FOVs of the one or more sides of the object. For example, top trail bank 216 and mirror 228 may be configured to capture images of the top and back surfaces of an object using imaging devices 234, 236, 238, and 240. In the illustrated embodiment, the banks of imaging devices 212, 214, 216, 218, 220, 222 and mirrors 224, 226, 228, 230 can be mechanically coupled to a support structure 242 above a conveyor 204. Note that although the illustrated mounting positions of the banks imaging devices 212, 214, 216, 218, 220, 222 relative to one another can be advantageous, in some embodiments, imaging devices for imaging different sides of an object can be reoriented relative to the illustrated positions in FIG. 2 (e.g., imaging devices can be offset, imaging devices can be placed at the corners, rather than the sides, etc.). Similarly, while there can be advantages associated with using four imaging devices per bank that are each configured to acquire image data from one or more sides of an object, in some embodiments, a different number or arrangement of imaging devices, a different arrangement of mirror (e.g., using stecrable mirrors, using additional fixed mirrors, etc.) can be used to configure a particular imaging device to acquire images of multiple sides of an object. In some embodiments, an imaging device can be dedicated to acquiring images of multiple sides of an object including with overlapping acquisition areas relative to other imaging devices included in the same system.

In some embodiments, system 200 also includes a dimensioner 206 and an image processing device 232. As discussed above, multiple objects 208a, 208b and 208c may be supported in the conveyor 204 and travel through the tunnel 202 along a direction indicated by arrow 210. In some embodiments, each bank of imaging devices 212, 214, 216, 218, 220, 222 (and each imaging device in a bank) can generate a set of images depicting a FOV or various FOVs of a particular side or sides of an object supported by conveyor 204 (e.g., object 208a).

In some embodiments, each imaging device (e.g., imaging devices in imaging device banks 212, 214, 216, 218, 220, 222) can be calibrated (e.g., as described below in connection with FIGS. 12A to 12C) to facilitate mapping a 3D location of each corner of an object supported by conveyor 204 (e.g., objects 208) to a 2D location in an image captured by the imaging device.

Note that although FIGS. 1A, 1B and 2 depict a dynamic support structure (e.g., conveyor 116, conveyor 204) that is moveable, in some embodiments, a stationary support structure may be used to support objects to be imaged by one or more imaging devices. In some embodiments (not shown), the objects to be imaged can be passed through the coverage area by an operator temporarily until the desired vision operations have been completed. FIG. 3 shows another example system for capturing multiple images of each side of an object in accordance with an embodiment of the technology. In some embodiments, system 300 can include multiple imaging devices 302, 304, 306, 308, 310, and 312, which can each include one or more image sensors, at least one lens arrangement, and at least one control device (e.g., a processor device) configured to execute computational operations relative to the image sensor. In some embodiments, imaging devices 302, 304, 306, 308, 310, and/or 312 can include and/or be associated with a steerable mirror (e.g., as described in U.S. application Ser. No. 17/071,636, filed on Oct. 13, 2020, which is hereby incorporated by reference herein in its entirety). Each of the imaging devices 302, 304, 306, 308, 310, and/or 312 can selectively acquire image data from different fields of view (FOVs), corresponding to different orientations of the associated stecrable mirror(s). In some embodiments, system 300 can be utilized to acquire multiple images of each side of an object. While FIG. 3 illustrates multiple imaging devices 302, 304, 306, 308, 310, and 312, it should be understood that in some embodiments system 300 can include one imaging device or can include various combinations of two or more imaging devices.

In some embodiments, system 300 can be used to acquire images of multiple objects presented for image acquisition. For example, system 300 can include a support structure that supports each of the imaging devices 302, 304, 306, 308, 310, 312 and a platform 316 configured to support one or more objects 318, 334, 336 to be imaged (note that each object 318, 334, 336 may be associated with one or more symbols, such as a barcode, a QR code, etc.). For example, a transport system (not shown), including one or more robot arms (e.g., a robot bin picker), may be used to position multiple objects (e.g., in a bin or other container) on platform 316. In some embodiments, the support structure can be configured as a caged support structure. However, this is merely an example, and support structure can be implemented in various configurations. In some embodiments, support platform 316 can be configured to facilitate imaging of the bottom side of one or more objects supported by the support platform 316 (e.g., the side of an object (e.g., object 318, 334, or 336) resting on platform 316). For example, support structure 316 can be implemented using a transparent platform, a mesh or grid platform, an open center platform, or any other suitable configuration. Other than the presence of support structure 316, acquisition of images of the bottom side can be substantially similar to acquisition of other sides of the object. As a further example, a transport system (not shown), including one or more robot arms (e.g., a robot bin picker), may be used to select and/or position multiple objects (e.g., in a bin or other container) on the support platform 316.

In some embodiments, imaging devices 302, 304, 306, 308, 310, and/or 312 can be oriented such that a FOV of the imaging device can be used to acquire images of a particular side of an object resting on support platform 316, such that each side of an object (e.g., object 318) placed on and supported by support platform 316 can be imaged by imaging devices 302, 304, 306, 308, 310, and/or 312. For example, imaging device 302 can be mechanically coupled to the support structure above support platform 316, and can be oriented toward an upper surface of support platform 316, imaging device 304 can be mechanically coupled to the support structure below support platform 316, and imaging devices 306, 308, 310, and/or 312 can each be mechanically coupled to a side of the support structure, such that a FOV of each of imaging devices 306, 308, 310, and/or 312 faces a lateral side of support platform 316.

In some embodiments, each imaging device can be configured with an optical axis that is generally parallel with another imaging device, and perpendicular to other imaging devices (e.g., when the steerable mirror is in a neutral position). For example, imaging devices 302 and 304 can be configured to face each other (e.g., such that the imaging devices have substantially parallel optical axes), and the other imaging devices can be configured to have optical axis that are orthogonal to the optical axis of imaging devices 302 and 304.

Note that although the illustrated mounting positions of the imaging devices 302, 304, 306, 308, 310, and 312 relative to one another can be advantageous, in some embodiments, imaging devices for imaging different sides of an object can be reoriented relative the illustrated positions of FIG. 3 (e.g., imaging device can be offset, imaging devices can be placed at the corners, rather than the sides, etc.). Similarly, while there can be advantages (e.g., increased acquisition speed) associated with using six imaging devices that is each configured to acquire imaging data from a respective side of an object (e.g., the six side of object 118), in some embodiments, a different number or arrangement of imaging devices, a different arrangement of mirrors (e.g., using fixed mirrors, using additional moveable mirrors, etc.) can be used to configure a particular imaging device to acquire images of multiple sides of an object. For example, fixed mirrors disposed such that imaging devices 306 and 310 can capture images of a far side of object 318 and can be used in lieu of imaging devices 308 and 312. In some embodiments, system 300 can be configured to image each of the multiple objects 318, 334, 336 on the platform 316.

In some embodiments, system 300 can include a dimensioner 330. As described above with respect to FIGS. 1A, 1B and 2, a dimensioner can be configured to determine dimensions and/or a location of an object supported by support structure 316 (e.g., object 318, 334, or 336). As mentioned above, in some embodiments, dimensioner 330 can determine 3D coordinates of each corner of the object in a coordinate space defined with reference to one or more portions of system 300. For example, dimensioner 330 can determine 3D coordinates of each of eight corners of an object that is at least roughly cuboid in shape within a Cartesian coordinate space defined with an origin at dimensioner 330. As another example, dimensioner 330 can determine 3D coordinates of each of eight corners of an object that is at least roughly cuboid in shape within a Cartesian coordinate space defined with respect to support platform 316 (e.g., with an origin that originates at a center of support platform 316).

In some embodiments, each imaging device (e.g., imaging devices 302, 304, 306, 308, 310, and 312) can be calibrated (e.g., as described below in connection with FIGS. 12A to 12C) to facilitate mapping a 3D location of each corner of an object supported by support platform 316 (e.g., object 318) to a 2D location in an image captured by the imaging device with the steerable mirror in a particular orientation.

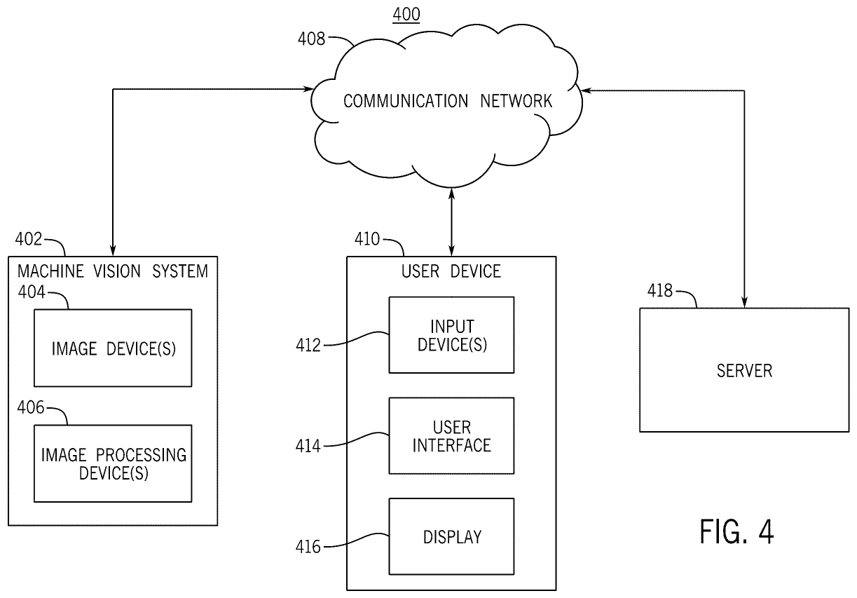

In some embodiments, an image processing device 332 can coordinate operations of imaging devices 302, 304, 306, 308, 310, and/or 312 and/or can perform image processing tasks as described above in connection with image processing device 132 of FIG. 1A and/or image processing device 410 discussed below in connection with FIG. 4.

FIG. 4 shows a system for three dimensional (3D) field calibration of a machine vision system in accordance with an embodiment of the technology. In the illustrated example of FIG. 4, system 400 includes a machine vision system 402, a communication network 408, a user device 410, and a server 418. In some embodiments, the system 400 includes fewer, additional, or different components in different configurations than illustrated in FIG. 4. As one example, the system 400 may include multiple machine visions systems 402, multiple user devices 410, multiple servers 418 or a combination thereof. As another example, one or more components of the system 400 may be combined into a single device such as, e.g., user device 410 and server 418.

In some embodiments, the machine vision system 402, the user device 410 and the server 418 can communicate over one or more communication networks 408. In some embodiments, communicating network 408 can be any suitable communication network or combination of communication networks. For example, communication network 408 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 408 can be a local area network (LAN), a wide area network (WAN), a public network (e.g., the Internet), a private or semi-private network (e.g., a corporate or university intranet), any other suitable type of network, or any suitable combination of networks. Communications links shown in FIG. 4 can each be any suitable communications link or combination of communications links, such as wired links, fiber optic links, Wi-Fi links, Bluetooth links, cellular links, etc. In some embodiments, components of system 400 may communicate directly as compared to through communication network 408. In some embodiments, the components of system 400 may communicate through one or more intermediary devices not illustrated in FIG. 4.

As shown in FIG. 4, the machine vision system 402 may include one or more imaging devices 404 and one or more image processing devices 406. In some embodiments, the imaging device(s) 404 and imaging processing device(s) 406 may communicate over one or more wired or wireless communication lines or buses, or a combination thereof. In some embodiments, the machine vision system 402 may include fewer, additional, or different components in different configurations than illustrated in FIG. 4. In some embodiments, the machine vision system 402 may include one or more imaging devices 404 in a tunnel arrangement such as, for example, described above with respect to FIGS. 1A, 1B, 2 and 3. In one example, the image processing device 406 (e.g., image processing device 132) can receive images and/or information about each image (e.g., 2D locations associated with the image) from one or more imaging devices 404 (e.g., one or more of imaging devices 112a, 112b and 112c described above in connection with FIGS. 1A and 1B, imaging devices in imaging device banks 212, 214, 216, 218, 220, 222 described above in connection with FIG. 2, and/or imaging device 302, 304, 306, 308, 310, 312 described above in connection with FIG. 3). In some embodiments, the machine vision system 402 may also include a dimension sensing system (not shown), for example, dimensioner 150, dimensioner 206, dimensioner 330, described above with respect to FIGS. 1A, 1B, 2 and 3. As discussed above, the dimensioner may be used to provide dimension data about an object imaged by imaging devices 404 to the image processing device 406. In some embodiments, the dimensioner may be locally connected to image processing device 406 and/or connected via a network connection (e.g., via a communication network 408). Image processing device 406 can also receive input from any other suitable devices, such as a motion measurement device (not shown) configured to output a value indicative of movement of a conveyor over a particular period of time which can be used to determine a distance that an object has traveled (e.g., between when dimensions were determined and when each image of the object is generated). Image processing device 406 can also coordinate operation of one or more other devices, such as one or more light sources (not shown) configured to illuminate an object (e.g., a flash, a flood light, etc.) Additionally or alternatively, image processing device 406 can execute a portion of a symbol decoding process to identify and/or decode symbols (e.g., barcodes, QR codes, text, etc.) associated with an object imaged by imaging devices 404 using any suitable technique or combination of techniques.

In some embodiments, imaging device(s) 404 can be any suitable imaging devices. For example, each including at least one imaging sensor (e.g., a CCD image sensor, a CMOS image sensor, or other suitable sensor), at least one lens arrangement, and at least one control device (e.g., a processor device) configured to execute computational operations relative to the imaging sensor. In some embodiments, a lens arrangement can include a fixed-focus lens. Additionally or alternatively, a lens arrangement can include an adjustable focus lens, such as a liquid lens or a known type of mechanically adjusted lens. Additionally, in some embodiments, imaging devices 302 can include a steerable mirror that can be used to adjust a direction of a FOV of the imaging device. In some embodiments, one or more imaging devices 404 can include a light source(s) (e.g., a flash, a high intensity flash, a light source described in U.S. Patent Application Publication No. 2019/0333259, etc.) configured to illuminate an object within a FOV. In some embodiments, imaging device(s) 404 may be similar to, for example, the imaging devices 112, 234, 236, 238, 240, 302, 304, 306, 308, 310, and 312 as discussed above with respect to FIGS. 1A, 1B, 2 and 3.

In some embodiments, imaging device(s) 404 can be local to an image processing device 406. For example, imaging devices 404 can be connected to image processing device 406 by a cable, a direct wireless link, etc. Additionally or alternatively, in some embodiments, imaging devices 404 can be located locally and/or remotely from image processing device 406, and can communicate data (e.g., image data, dimension and/or location data, etc.) to image processing device 406 (and/or server 418) via a communication network (e.g., communication network 408). In some embodiments, one or more imaging devices 404, image processing devices 406, and/or any other suitable components can be integrated as a single device (e.g., within a common housing).

As shown in FIG. 4, user device 410 can include one or more input device(s) 412, a user interface 414, and a display 416. User device 410 may be configured to enable an operator or user to perform a 3D field calibration of the machine vision system 402, as discussed further below. Input device(s) 412 can be configured to receive data or information from a user or operator. In some embodiments, input device(s) can include any suitable input devices and/or sensors that can be used to receive user input, such as a keyboard, a mouse, a touchscreen, a microphone, etc. User interface 414 may be configured to provide one or more graphical user interfaces (GUIs) that are configured to allow the user to interact with (e.g., provide input to and receive output from) the user device 410. In some embodiments, the GUIs may be displayed to a user on display 416. In some embodiments, display 416 can include any suitable display devices, such as a computer monitor, a touchscreen, a television, a smartphone, a tablet, etc. In some embodiments, the GUIs may be generated using a processor device (not shown) on user device 410 or may be generated by a separate device such as, for example, server 418 and transmitted to the user device 410 (e.g., over the communication network 408) as discussed further below. The user device 410 may also include other components not illustrated such as, for example, a processor device (e.g., a microprocessor, an application-specific integrated circuit (ASIC), or another suitable electronic device), a memory (e.g., a non-transitory, computer readable medium), a communication system (e.g., a transceiver) for communicating over the communication network 408 and, optionally, one or more additional communication networks or connections.

In some embodiments, image processing device 406, user device 410, and/or server 418 can be any suitable computing device or combination of devices, such as a desktop computer, a laptop computer, a smartphone, a tablet computer, a wearable computer, a server computer, a virtual machine being executed by a physical computing device, etc.

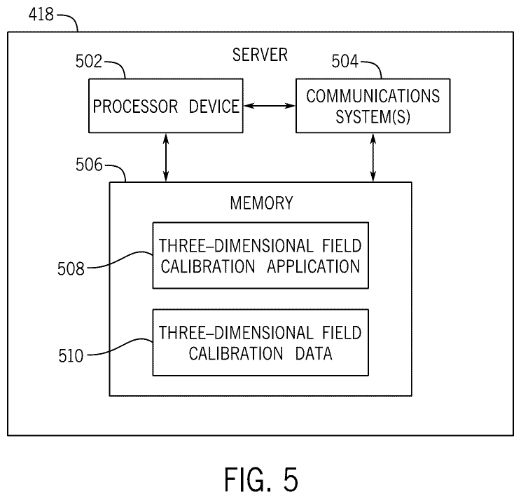

In some embodiments, image processing device 410 can communicate image data (e.g., images received from the imaging device(s) 404) and/or data received from a dimension sensing system (not shown) to a server 418 or user device 410 over communication network 408. In some embodiments, user device 410 can communicate data to and receive data from the server 418, for example, data for 3D field calibration of machine vision system 402, over communication network 408. FIG. 5 shows an example of a server 418 in the system shown in FIG. 4 in accordance with an embodiment of the technology. As shown in FIG. 5, server 418 can include a processor device 502, one or more communications systems 504, and/or memory 506. The processor device 502, the communications system 504, and the memory 506 may communicate over one or more wired or wireless communication lines or buses, or a combination thereof. The server 418 may include additional components than those illustrated in FIG. 5 in various configurations. For example, the server 418 may also include one or more inputs such as, for example, a keyboard, a mouse, a touchscreen, a microphone, etc. that receive inputs from the user. In another example server 418 may also include a display such as for example a computer monitor, a touchscreen, a television, etc. The server 418 may also perform additional functionality other than the functionality described here. Also, the functionality described herein as being performed by the server 418 may be distributed among multiple servers or devices (e.g., as part of a cloud service or cloud-computing environment), combined with other components of the system 400 (e.g., combined with the user device 410, one or more components of the machine vision system 402, or the like), or a combination thereof.

In some embodiments, processor device 502 can be any suitable hardware processor or combination of processors, such as a CPU, a GPU, an ASIC, an FPGA, etc. In some embodiments, communications systems 504 can include any suitable hardware, firmware, and/or software for communicating information over communication network 408 (shown in FIG. 4) and/or any other suitable communication networks. For example, communications systems 504 can include one or more transceivers, one or more communication chips and/or chip sets, etc. that communicate with the machine vision system 402, the user device 410, or a combination thereof over the communication network 408. In a more particular example, communications systems 504 can include hardware, firmware and/or software that can be used to establish a Wi-Fi connection, a Bluetooth connection, a cellular connection, an Ethernet connection, etc.

In some embodiments, memory 506 can include any suitable storage device or devices that can be used to store instructions, values, etc., that can be used, for example, by processor device 502 to process data, to generate content (e.g., GUIs), to communicate with one or more user devices 410, to communicate with one or more machine vision systems 402, etc. Memory 506 can include any suitable volatile memory, non-volatile memory, storage, or any suitable combination thereof. For example, memory 506 can include RAM, ROM, EEPROM, one or more flash drives, one or more hard disks, one or more solid state drives, one or more optical drives, etc. In some embodiments, memory 506 can have encoded thereon a server program for controlling operation of server 418. For example, in such embodiments, processor device 502 can receive data from image processing device 406 (e.g., images associated with an object, etc.), image devices 404, and/or user device 410.

As shown in FIG. 5, the memory 506 can include a three-dimensional (3D) field calibration application 508. The 3D field calibration application 508 is a software application executable by the processor device 502 in the example illustrated and as specifically discussed below, although a similarly purposed module can be implemented in other ways in other examples. As described in more detail below, the processor device 502 executes the 3D field calibration application 508 to calibrate a machine vision system, for example, a tunnel system by automatically determining a calibration for one or more imaging devices (e.g., imaging device(s) 404) associated with the machine vision system 402. Memory 506 also can include 3D field calibration data 510. In some embodiments, the 3D field calibration data 510 can include data received from a user (e.g., calibration parameters), data collected using the tunnel 402 (e.g., image data captured by one or more imaging devices 404 and dimensioner data), and calibration data generated by, for example, the processor 502 and 3D field calibration application 508.

In some embodiments, the functionality described herein as being performed by the server 418 may be locally performed by the user device 410. For example, in some embodiments, the user device 410 may store 3D field calibration application 508, the 3D field calibration data 510, or a combination thereof. As described in further detail below, a user may use the user device 410 to calibrate a machine vision system 402 (e.g., a tunnel) via, e.g., the 3D field calibration application, the 3D field calibration data, or a combination thereof.

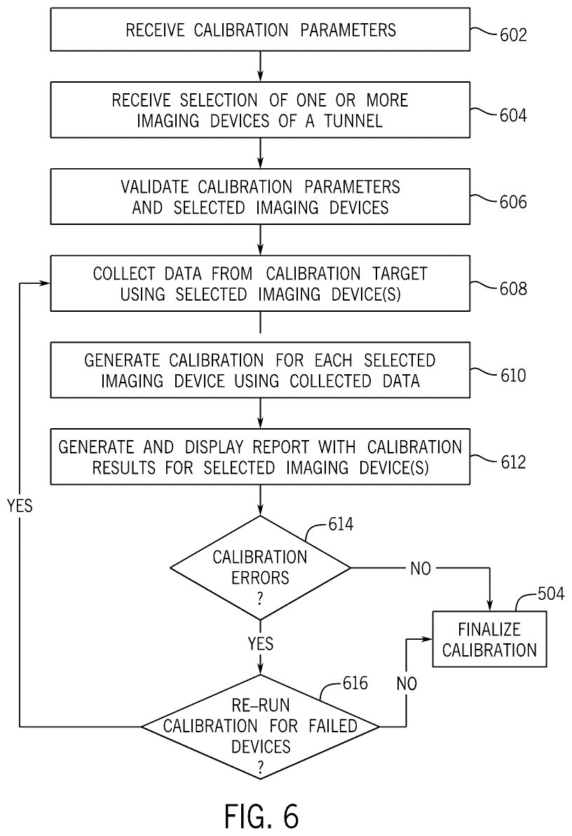

FIG. 6 illustrates a method for three-dimensional field calibration of a machine vision system in accordance with an embodiment of the technology. The method illustrated in FIG. 6 is described herein as being performed by the server 418 and, in particular, the 3D field calibration application 508 may be executed by the processor device 502. However, as noted above, the functionality described with respect to the method for 3D field calibration may be performed by other devices, such as the user device 410, component(s) of the machine vision system 402, or distributed among a plurality of devices, such as a plurality of servers included in a cloud device.

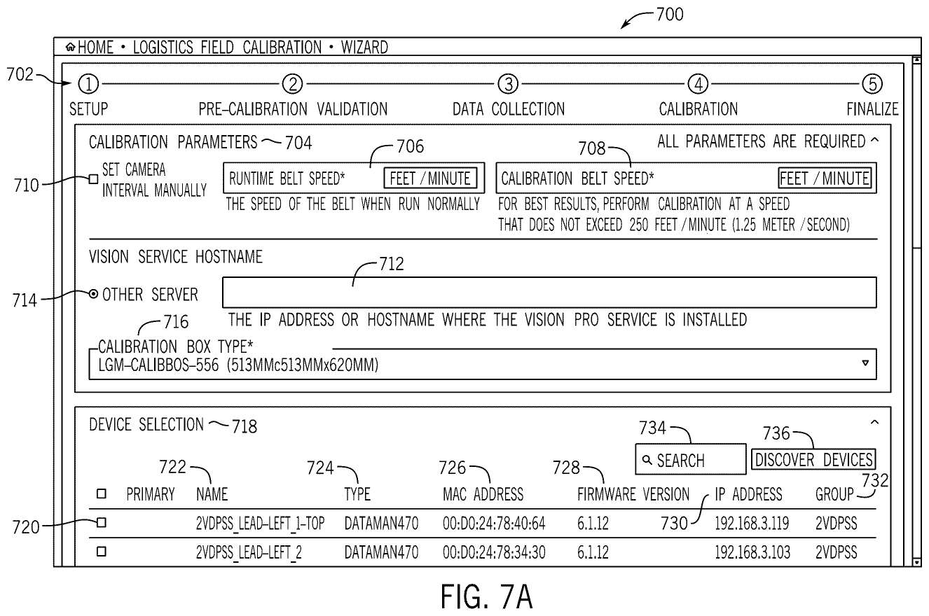

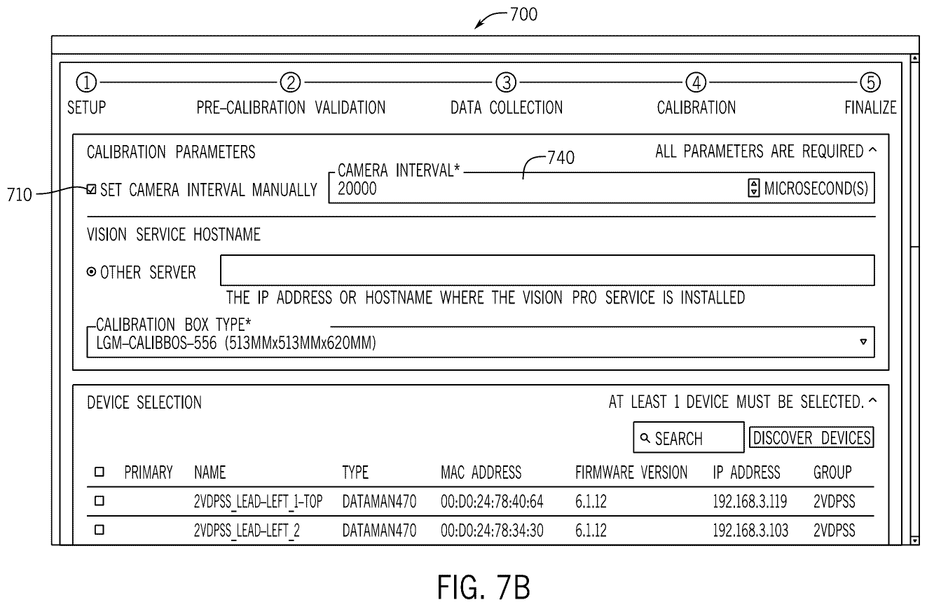

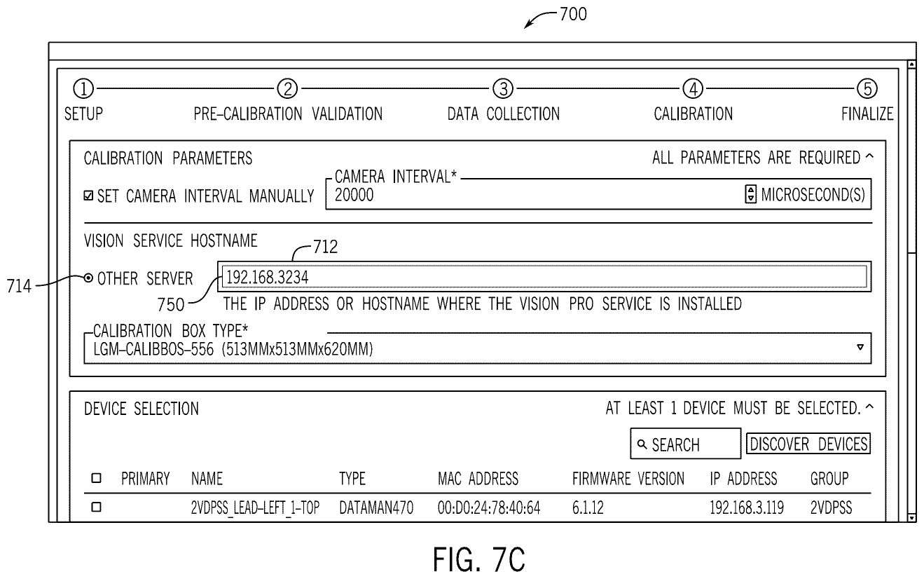

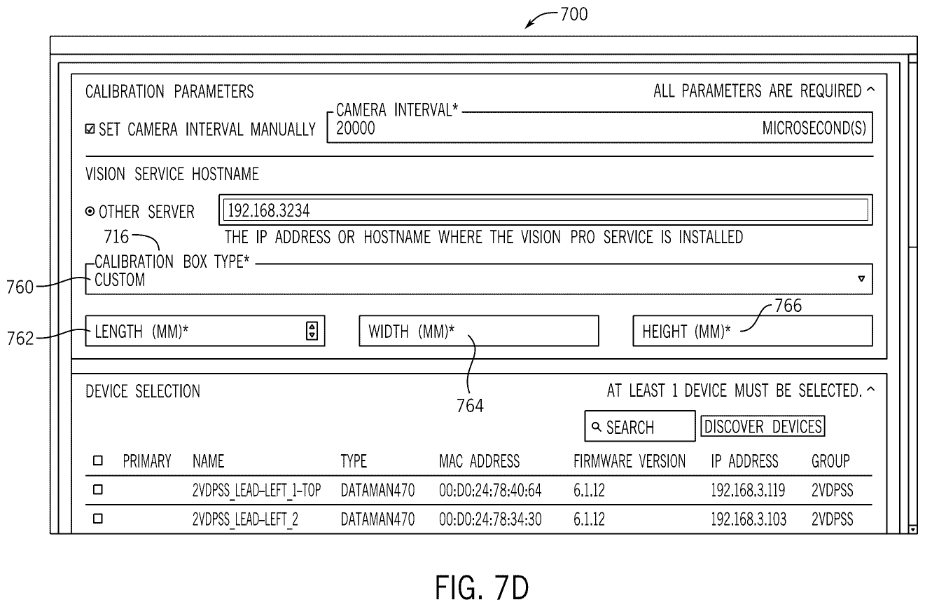

The process illustrated in FIG. 6 is described below with reference to elements of the system 400 for 3D field calibration of a machine vision system as illustrated in FIGS. 4 and 5 as well as with reference to FIGS. 7A-11 which are example screenshots of graphical user interfaces (GUIs) for 3D field calibration of a machine vision system. Although the blocks of the process are illustrated in a particular order, in some embodiments, one or more blocks may be executed in a different order than illustrated in FIG. 6, or may be bypassed.

At block 602, a set of calibration parameters may be received from a user. In some embodiments, the 3D field calibration application 508 may be configured to generate a user interface configured to receive inputs from a user. In some embodiments, the server 418 may transmit the generated graphical user interface to the user device 410. FIGS. 7A-7D illustrates an example setup user interface 700 that may be displayed (e.g., as a user interface 414 on display 416 of user device 410) to a user to receive data including calibration parameters. As illustrated in FIG. 7A, the setup user interface 700 can include a header 702 that indicates the steps of the 3D field calibration process and identifies (e.g., using a visual indicator) the current step being performed by the system 400. For example, in the user interfaces 7A-7D, the “Setup” visual indicator can be highlighted in a color (e.g., yellow). The setup user interface 700 can also include a section 704 for receiving calibration parameters from a user. In some embodiments, the calibration parameters can include, for example, a runtime conveyor (e.g., a belt) speed 706 (i.e., the runtime speed for a conveyor in the tunnel system 402) and a calibration conveyor speed 708 (i.e., the desired speed for the conveyor in the tunnel system 402 during calibration). The values for the runtime conveyor speed and the calibration conveyor speed may be input by the user in the boxes 706 and 708, respectively. In some embodiments, the 3D field calibration application 508 may be configured to automatically calculate one or more camera acquisition parameters, for example, a camera interval, for the imaging device(s) 404. For example, a camera interval may be calculated from the calibration conveyor speed. The calculated acquisition parameters (e.g., camera interval) can be used during data collection (e.g., as discussed further below with respect to block 608) for the 3D field calibration process. In some embodiments, calculated camera acquisition parameters may be the same as or different from the camera acquisition parameters in the customer's system settings for the tunnel system 402. In some embodiments, the 3D field calibration process may perform better at a slower conveyor speed. In some embodiments, the user may alternatively manually enter a camera acquisition parameter such as, for example, camera interval for the 3D field calibration process by, for example, selecting a check box 710. For example, once the check box 710 for manual entry of the camera interval has been selected by a user, a data entry box 740 may be displayed on the user interface 700 to receive the input camera interval value as shown in FIG. 7B.

Returning to FIG. 7A, in some embodiments, the calibration parameters 704 may also include an identifier of the location of a server or computing device (e.g., image processing device 406) associated with the control of the tunnel system 402. In the example shown in FIG. 7A, a selection 714 may be checked and box 712 can be used to input, for example, an IP address 750 (shown in FIG. 7C) or other connection address for the tunnel system 402. In some embodiments, the 3D field calibration application 508 may be configured to automatically discover suitable devices. In some embodiments, the calibration parameters may also include data 716 regarding for example, a type and dimensions of a calibration target (e.g., a box). In some embodiments, a drop down menu 716 may be provided with a list of predefined types and associated dimensions of calibration targets. In some embodiments, the drop down menu 716 may also include a “custom” option 760 as shown in FIG. 7D which allows a user to input the dimensions of the calibration targets For example, as shown in FIG. 7D, when the custom option 760 is selected, the user interface 700 may provide boxes for input of a length 762, width 764, and height 766 of the calibration target. It should be understood that in some embodiments, the user interface 700 may be configured to receive other types of calibration parameters. In some embodiments, the calibration parameters received at block 692 may be stored in the memory 506 of the server 418, for example, as part of the 3D field calibration data 510.

Once the calibration parameters 704 have been received at block 602, a selection of one or more imaging devices 404 of a tunnel system 402 to be calibrated may be received from a user at block 604. In the example user interface 700 shown in FIG. 7A, a drop down list 718 including the available imaging devices 404 in the tunnel system 402 may be displayed. A user may select one or more check boxes 720 to select one or more imaging devices for calibration. Each row of the list of available imaging devices may be a different imaging device 404 in the tunnel system 402 and may include, for example, a name 722 of the imaging device, a type 724 of the imaging device, a MAC address 726 of the imaging device, a software (or firmware) version 728 for the imaging device, an IP address 730 for the imaging device, and a group 732 with which the imaging device may be associated or assigned. In some embodiments, the user interface 700 includes a search box 734 which may be used to search for one or more specific imaging devices 404 of the tunnel system 402. In the example user interface 700 illustrated in FIG. 7A, the user interface can also include an option (e.g., button 736) that may be selected by the user to discover or identify the imaging devices 404 in the tunnel system 402, which can then be displayed in the list 718. In some embodiments, the selection of imaging device(s) received at block 604 and data associated with the selected imaging device(s) may be stored in the memory 506 of the server 418, for example, as part of the 3D field calibration data 510. Once the calibration parameters have been provided and the one or more imaging devices that are to be calibrated are selected, the user may provide an input, for example, select a button (not shown) in the user interface 700 requesting the 3D calibration application proceed to the next step.

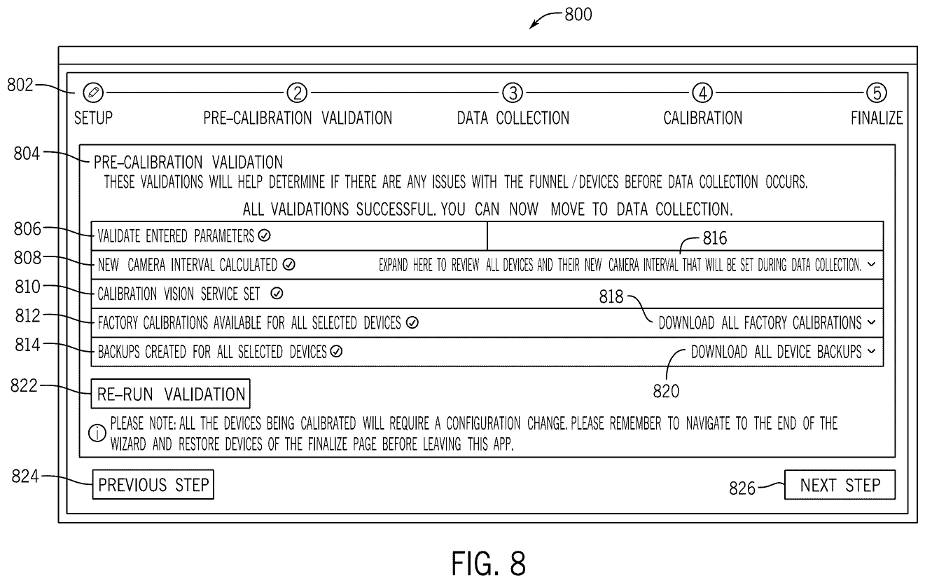

At block 606, the calibration parameters and selected imaging device can be automatically validated by, for example, the 3D field calibration application 508. In some embodiments, the 3D field calibration application 508 may be configured to generate a user interface configured to display the results of validation. In some embodiments, the server 418 may transmit the generated graphical user interface to the user device 410. FIG. 8 illustrates an example validation user interface 700 that may be displayed (e.g., as a user interface 414 on display 416 of user device 410) to a user to allow the user to view the results of the validation. As illustrated in FIG. 8, the validation user interface 800 can include a header 802 that indicates the steps of the 3D field calibration process and identifies (e.g., using a visual indicator) the current step being performed by the system 400. For example, in in the user interface 800, the “Pre-Calibration Validation” visual indicator can be highlighted in a color (e.g., yellow) and the “Setup” visual indicator include an edit icon (e.g., a pencil) to indicate that the “Setup” step was completed but may also be edited if needed. The validation user interface 800 can also include a section 804 for displaying the results of the validation including, for example, whether a particular validation item has been successful or unsuccessful. For example, in FIG. 8 a check mark (e.g., a check mark displayed in a color such as, for example, green) may be used to indicate that a particular validation was successful. In some embodiments, an unsuccessful validation may be indicated using, for example, an X (not shown). In some examples, the X may be displayed in a color such as, for example, red. In the example shown in FIG. 8, the pre-calibration validations 804 can include a validation 806 of the entered calibration parameters (e.g., the received calibration parameters from block 602), a validation 808 of the calculated camera acquisition parameters such as, for example, a new camera interval (e.g., automatically calculated by the 3D field calibration application 508) for data collection for calibration, a validation 810 the calibration vision service is set (i.e., the IP address (or hostname) for the tunnel system 402), a validation 812 that the factory calibrations are available for all selected imaging services, and a validation 814 that backups of the customer system settings have been created for all selected imaging devices. In some embodiments, the validation results of the validation at block 606 may be stored in the memory 506 of the server 418, for example, as part of the 3D field calibration data 510.

In some embodiments, the 3D field calibration application 508 may be configured to automatically create and store backups of the existing customer system settings (e.g., including the customer system setting for the camera interval and other camera acquisition parameters) for the selected imaging device(s). In some embodiments, the backups of the customer system settings may be created and stored based on inputs or instructions received from a user. For the camera acquisition parameter validation 808, in some embodiments the validation user interface 800 may also include a drop down selection 816 that allow a user to view and review the selected imaging device and the new camera acquisition parameter(s) (e.g., a new camera interval as shown in FIG. 8) that were automatically calculated by, for example, the 3D field calibration application 508, and that will be set during the data collection for the calibration. For the factory calibration validation, in some embodiments, the validation user interface 800 may also include a drop-down selection 818 that allows a user to download the factory calibrations. For the backup creation validation, in some embodiments, the validation user interface 800 may also include a drop down selection 820 to allow a user to download the imaging device backups. In some embodiments, the validation user interface 800 may also include an input (e.g., a button) 822 to allow a user to re-run the validation, for example, if one of the validations 806, 808, 810, 812, 814 has failed, a user can return (e.g., using an input button 824) to the setup user interface to change or renter data. Once the validations are completed and successful, the user may provide an input, for example, select a button 826 in the user interface 800 requesting the 3D calibration application 508 proceed to the next step.

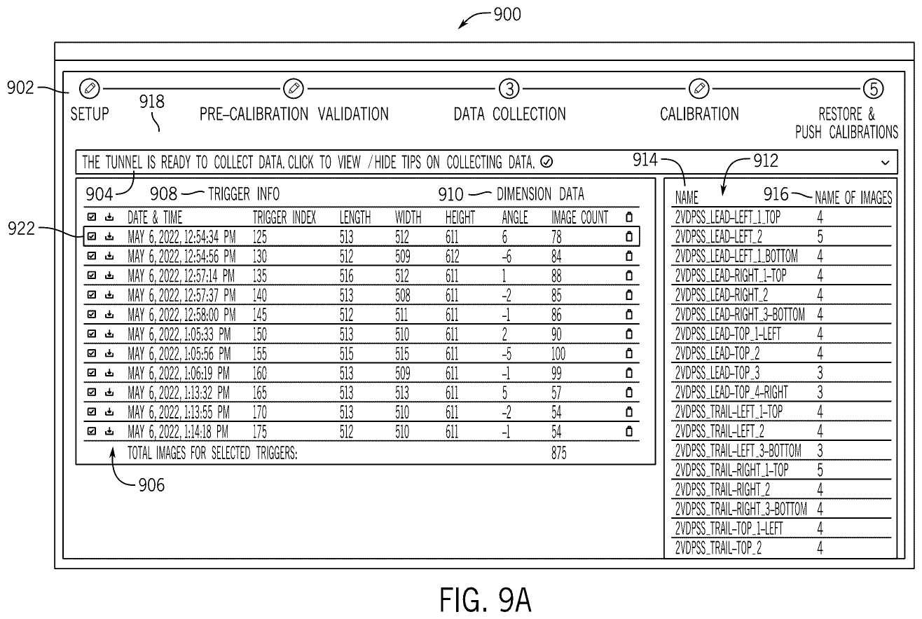

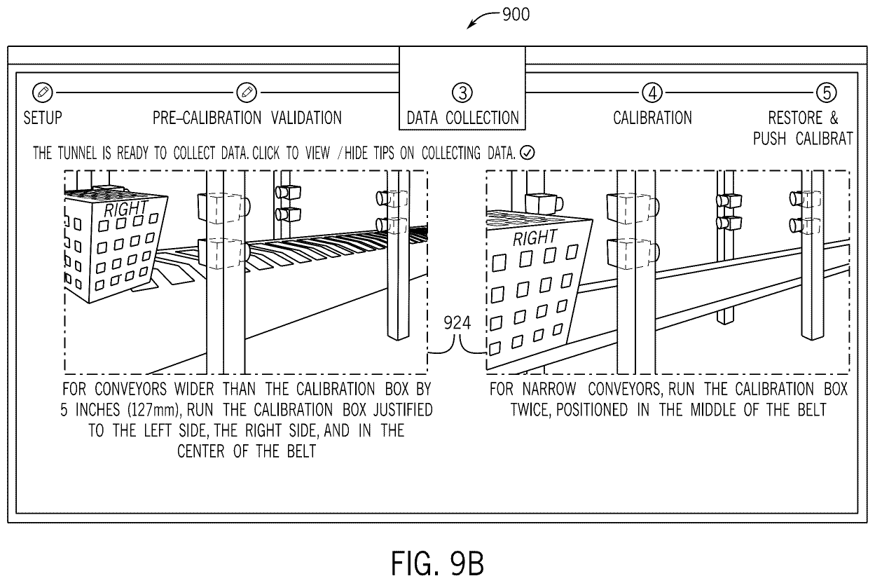

At block 608, data collection for the 3D field calibration can be performed using the tunnel system 402, a calibration target (e.g., a box), and the 3D field calibration application 508. In some embodiments, the 3D field calibration application 508 may be configured to generate a user interface configured to allow a user to select and display triggers for data collection from the selected imaging device(s) 404. In some embodiments, the server 418 may transmit the generated graphical user interface to the user device 410. FIGS. 9A and 9B illustrate an example data collection user interface 900 that may be displayed (e.g., as a user interface 414 on display 416 of user device 410) to a user to allow the user to select and display the collected data for the triggers used for the data collection from the selected imaging device(s). As used herein, the term “trigger” refers to the object (or acquisition cycle or pass of the object) describing one run of at least one imaging device and controls the image acquisition, the decoding of the acquired images, the assembly of the result, and the distribution of the result. As illustrated in FIG. 9A, the validation user interface 900 can include a header 902 that indicates the steps of the 3D field calibration process and identifies (e.g., using a visual indicator) the current step being performed by the system 400. For example, in in the user interface 900, the “Data Collection” visual indicator can be highlighted in a color (e.g., yellow) and the “Setup” visual indicator and “Pre-Calibration Validation” visual indicator include an edit icon to indicate that these steps have been completed but may also be edited is needed.

The data collection user interface 900 can also include an indication 904 that a tunnel system (e.g., tunnel system 402) is ready to collect data. A user can then run a calibration target (e.g., a box) through the tunnel system to acquire, for example, images from each selected imaging device and dimensioner data. In some embodiments, as shown in FIG. 9B, the data collection user interface 900 can include a link 918 that allows a user to view an explanation (or tips) 924 on how to run the calibration target (e.g., a box) through the tunnel to collect data for calibration. For example, as shown in FIG. 9B, the explanation (or tips) 924 may include an animation and text. Returning to FIG. 9A, in the example data collection user interface 900, as discussed above, each scan of the calibration target (i.e., running the calibration target through the tunnel, acquiring images, dimensioner data, etc.) using the selected imaging device(s) 404 may be referred to as a trigger. In some embodiments, data collection user interface 900 is configured to display a list 906 of completed scans or triggers for the calibration target. In some embodiments, the entry in list 906 for each completed trigger can include trigger information 908 and dimensioner data 910 acquired for the calibration target. In some embodiments, the trigger information 908 can include, for example, a date and time for the trigger and a trigger index. In some embodiments, the dimensioner data 910 can include, for example, length, width, height, angle, and an image count. The image count can indicate the aggregate count of all images from all devices (e.g., all of the imaging devices selected for calibration) for the specific trigger. In some embodiments, the data collection user interface 900 can highlight problems that would prevent a successful calibration. For example, a non-calibration object may be detected and dimensioned, but may be flagged as erroneous based on one or more failure checks (e.g., incorrect length). In some embodiments, the data collection user interface 900 can also be configured to display a listing 912 of the selected imaging devices 402 used to collect data for a scan or trigger. As shown in FIG. 9A, the listing 912 can include the name 914 of each imaging device and the number of images 916 acquired using each imaging device during the scan or trigger. In some embodiments, for each scan or trigger, the calibration target may be placed at a different position on, for example, the conveyer of the tunnel system (e.g., the center of the conveyor, the right side of the conveyor, the left side of the conveyor, etc.). In some embodiments, the data (e.g., images and dimensioner data) collected for each trigger and imaging device at block 608 may be stored in the memory 506 of the server 418, for example, as part of the 3D field calibration data 510 When data collection at block 608 is competed, a user may select one or more of the triggers (e.g., using a check box 922 for each trigger) for calibration. In some embodiments, once one or more of the triggers have been selected, the user may provide an input, for example, select a button (not shown) in the user interface 900 requesting the 3D calibration application 508 proceed to the next step.

At block 610, a calibration for each selected imaging device may be automatically generated using the data collected for each selected trigger and at block 612 a report may be gencrated and displayed with the calibration results for the selected imaging device(s). For example, in some embodiments, the 3D field calibration application 508 and processor device 502 may be configured to automatically calculate and generate calibration data for each imaging device based on the data collected at block 606 and to generate a report. In some embodiments, each selected imaging device may be calibrated (e.g., as described below in connection with FIGS. 12A to 12C) to facilitate mapping a 3D location of each corner of an object supported by a conveyor 116, 204 (e.g., objects 118, 208) or supported by a support platform 316 (e.g., object 218) to a 2D location in an image captured by the imaging device. In some embodiments, image processing device 132 can map 3D locations of one or more corners of an object to a 2D location within each image in set of images output by each imaging device (e.g., as described below in connection with FIGS. 13A and 13B). Accordingly, the 3D location of each corner can be mapped to a 2D location in an image by an imaging device with a particular FOV at a particular time.

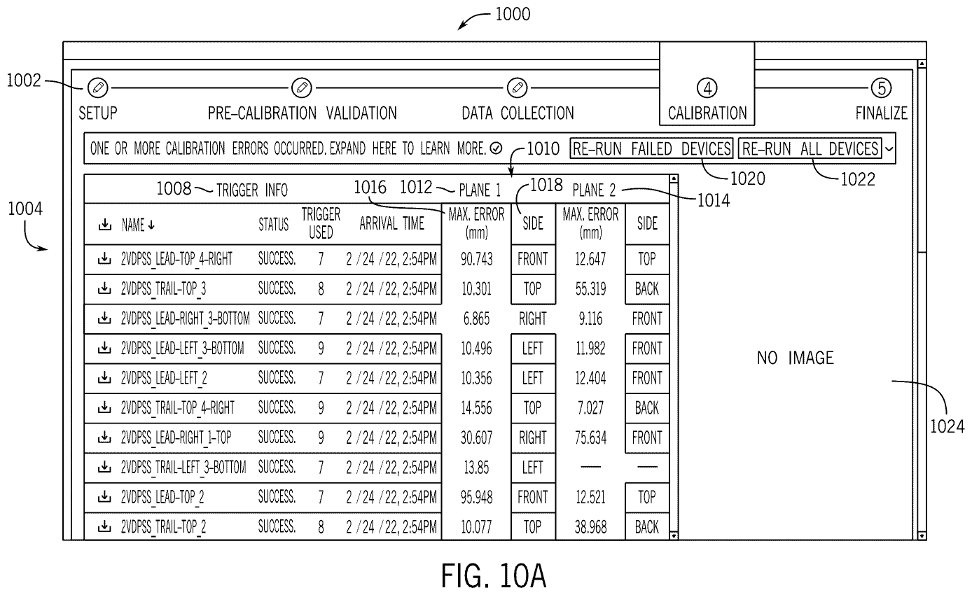

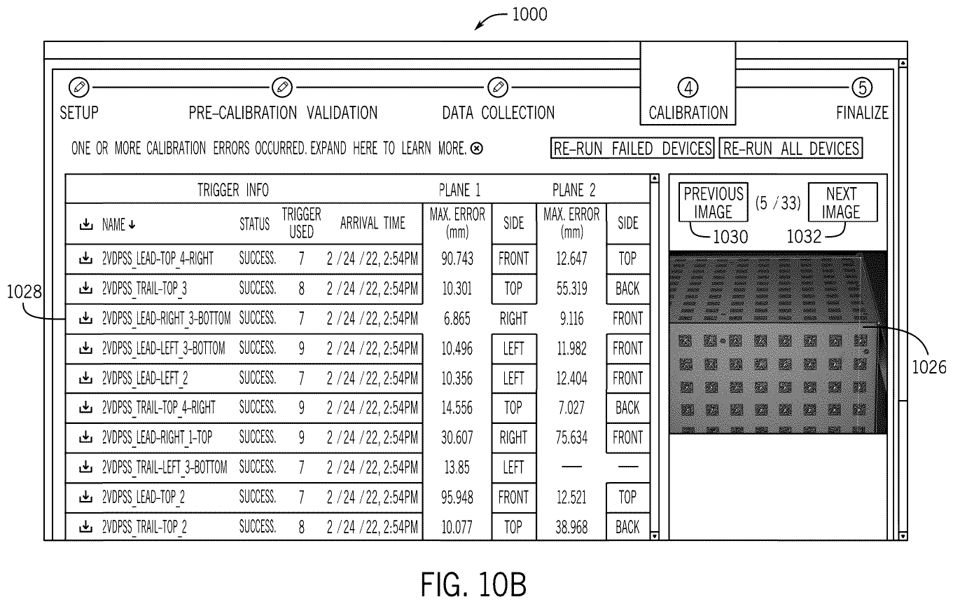

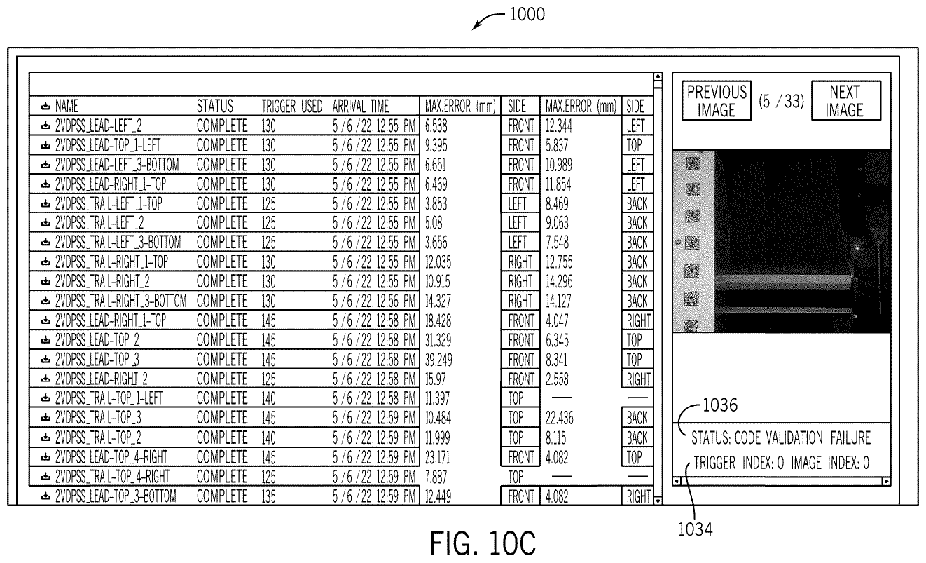

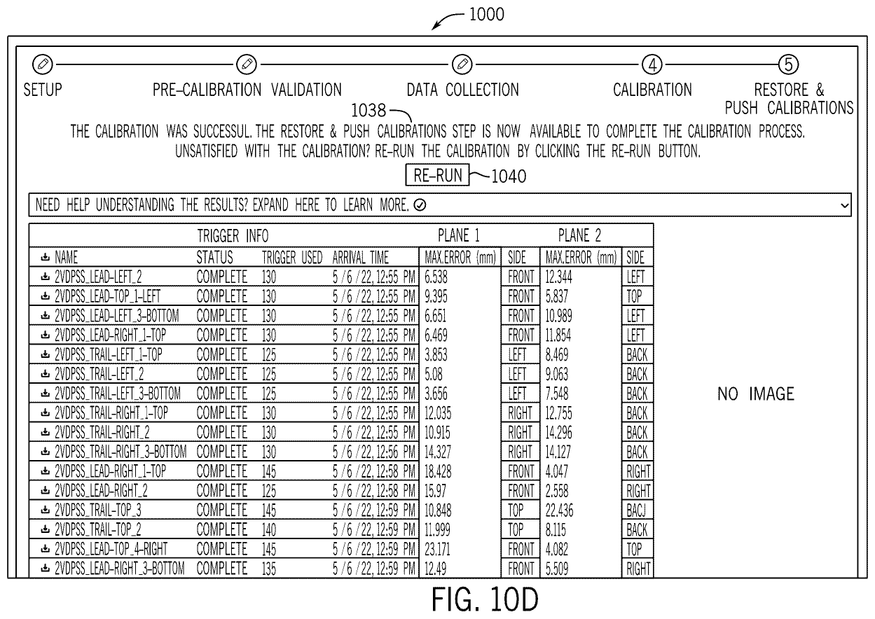

In some embodiments, the 3D field calibration application 508 may be configured to generate a user interface configured to allow a user to view the calibration data and results for each selected imaging device 404. In some embodiments, the server 418 may transmit the generated graphical user interface to the user device 410. FIGS. 10A-10D illustrate an example calibration user interface 1000 that may be displayed (e.g., as a user interface 414 on display 416 of user device 410) to a user to allow the user to view the calibration data and results. As illustrated in FIG. 10A, the validation user interface 1000 can include a header 1002 that indicates the steps of the 3D field calibration process and identifies (e.g., using a visual indicator) the current step being performed by the system 400. For example, in in the user interface 1000, the “Calibration” visual indicator can be highlighted in color (e.g., yellow) and the “Setup” visual indicator, “Pre-Calibration Validation,” and “Data Collection” visual indicators include an edit icon to indicate that these steps have been completed but may also be edited if needed.

As shown in FIG. 10A, the calibration user interface 1000 may include a listing of the selected imaging device(s) 404 (i.e., selected for calibration at block 604) that includes the generated calibration data and results. In some embodiments, the calibration user interface 1000 may include an indication 1006 whether there were any calibration errors for one or more of the imaging devices 404. In some embodiments, the listing 1004 of imaging devices 404 can include trigger information 1008 and calibration data and results 1010 for each imaging device. In some embodiments, the trigger information 1008 can include the name of the imaging device, a status (e.g., whether the calibration of the imaging device was successful), an identifier of the trigger used (e.g., the trigger with the best calibration result, i.e., the lowest max plane errors or other criteria), and an arrival time. As shown in FIG. 10A, in some embodiments, the calibration data and results can be provided for one or more planes, for example a first plane 1012 and a second plane 1014. In some embodiments, the generated calibration data can include a determined error between where a target (e.g., a symbol) on the calibration target (e.g., a box) was found from the collected data and where the target was expected to be found. In the example calibration user interface 1000 of FIG. 10A, a maximum error 1016 for each plane for an imaging device is shown as well as a side 1018 of the calibration target where the target symbol was found on the calibration target (e.g., a cuboid with symbols at known locations). In some embodiments, the “Max Error” 1016 is the maximum difference between the actual reported symbol center location and the calculated symbol center location of all of the symbols found on the plane converted from pixels to mm.

In some embodiments, the generated calibration data can also include an evaluation or determination of whether the maximum error for an imaging device is acceptable. In some embodiments, the determination of whether the maximum error for an imaging device is acceptable (e.g., performed by the 3D field calibration application 508 and processor device 502) can be determined by comparing the maximum error to predetermined error thresholds. In the example calibration user interface 1000 shown in FIG. 10A, the calibration results for each imaging device are indicated by highlighting the maximum error information with a color. In one example, if the maximum error for an imaging device is less than a first predetermined error threshold (e.g., 25 mm), the maximum error is within an acceptable tolerance and highlighted in green. In this example, if the maximum for the imaging device is greater than the first predetermine error threshold by less than a second predetermined threshold (e.g., >25 mm and <50 mm), the maximum error is within an acceptable tolerance, but higher than recommend, and highlighted in yellow. In addition, in this example, if the maximum error for the imaging device is greater than the second predetermined threshold (e.g., >50 mm), the maximum error is unacceptable (i.e., a calibration failure) and highlighted in red. In some embodiments, the calibration data and results generated for each imaging device at blocks 610 and 612 may be stored in the memory 506 of the server 418, for example, as part of the 3D field calibration data 510.

In some embodiments, the calibration user interface 1000 may also include an area 1024 to display one or more images associated with an imaging device selected from listing 1004. If a user selects an imaging device 1028 from listing 1004, one or more images 1026 may be displayed as shown in FIG. 10B. In some embodiments, an input 1030 (e.g., a button “Previous Image,” a filmstrip or other navigation control) and an input 1032 (e.g., a button “Next Image,” a filmstrip or other navigation control) may be provided to allow a user to scroll through and view each of the images associated with the selected imaging device 1028. In some embodiments, the calibration user interface 1000 may also provide feedback to a user regarding why certain images associated with the selected imaging device 1028 may not have been used for calibration. As shown in FIG. 10C, in some embodiments, the calibration user interface 1000 can be configured to provide an error message 1034 on a collected image that was not used in the calibration and may also include identifying information 1036 for the image such as, for example a trigger index where the image comes from and an image index for that trigger FIG. 10D illustrates an example of a calibration user interface 1000 where the calibration of all imaging devices (e.g., all of the imaging devices selected for calibration) has been successful. In this example, the calibration user interface 1000 can include an indication 1038 (e.g., using text) that the calibration was successful and that the process can be completed, for example, using the finalization step discussed further below.

At block 614, if there are calibration errors (e.g., if the calibration of an imaging device failed or if the maximum error was unacceptable) or if the user is not satisfied with the calibration results, the user may select to re-run the calibration for the failed imaging devices at block 616. In some embodiments, the calibration user interface 1000 may include an input, for example, button 1020 (shown in FIG. 10A) to allow a user to select to re-run the calibration for the failed imaging devices and/or button 1022 (shown in FIG. 10A) to allow a user to select to re-run the calibration for all imaging devices and/or a button 1040 (shown in FIG. 10D) to re-run the calibration after a successful calibration. If the user selects to re-run the calibration for one or more imaging devices, the process returns to block 608 for data collection. If there are no calibration errors or failures at block 614 or if the user does not select to re-run the calibration for one or more imaging devices at block 616, the calibration may be finalized at block 618. In some embodiments, the user may provide an input, for example, select a button (not shown) in the user interface 1000 requesting the 3D calibration application 508 proceed to the next step.

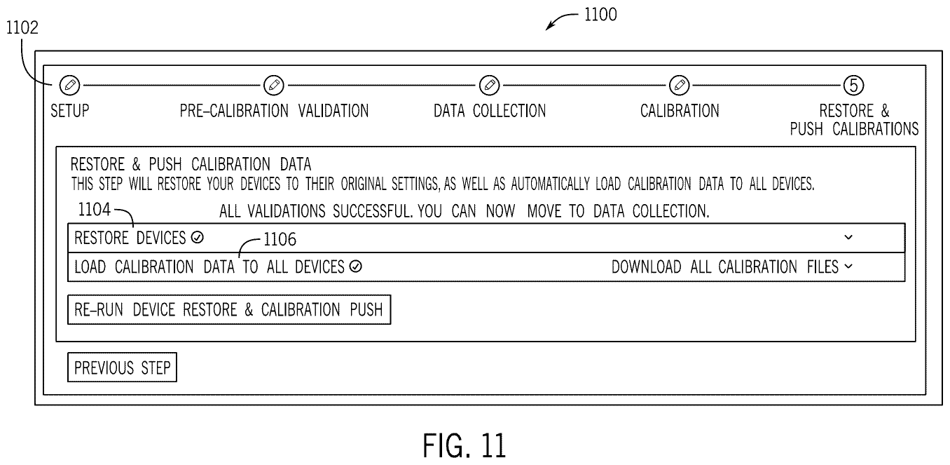

In some embodiments, the 3D field calibration application 508 may be configured to generate a user interface configured to allow a user to finalize the calibration results. In some embodiments, the server 418 may transmit the generated graphical user interface to the user device 410. FIG. 11 illustrates an example finalization user interface 1100 that may be displayed (e.g., as a user interface 414 on display 416 of user device 410) to a user to allow the user to finalize the field calibration, for example, to restore customer system settings and push calibration data. As illustrated in FIG. 11, the finalization user interface 1100 can include a header 1102 that indicates the steps of the 3D field calibration process and identifies (e.g., using a visual indicator) the current step being performed by the system 400. For example, in in the user interface 1100, the “Finalize” visual indicator can be highlighted in color (e.g., yellow) and the “Setup” visual indicator, “Pre-Calibration Validation,” “Data Collection” visual indicator, and “Calibration” visual indicator include an edit icon to indicate that these steps have been completed but may also be edited if needed.

At block 618, in some embodiments, one or more finalization steps may be automatically performed by, for example, the 3D field calibration application 508 and processor device 502. In some embodiments, the 3D field calibration system 400 (e.g., the processor 502 and 3D field calibration application 508) is configured to automatically restore the imaging device(s) selected for calibration to the customer system settings. In some embodiments, the 3D field calibration system 400 may also be configured to load the calibration data generated at block 610 to, for example, the imaging device(s) selected for calibration. The finalization user interface 1100 can also include a section for displaying the results of one or more of the finalization steps, for example, whether the restore device 1004 step and the load calibration data to all devices 1106 step were successful. In some embodiments, the finalization user interface 1100 may also include an input to allow a user to select to re-run the finalization steps (e.g., if one or more of the finalization steps was not successfully completed). In some embodiments, the restore devices section 1104 may allow the user to select to view the results of the restoration of the customer system settings for the imaging devices using, for example, a drop down list. In some embodiments, the load calibration data section 1106 may allow a user to select to view the results of all the calibration data pushes using, for example a drop down list. In some embodiments, the finalization user interface 100 may also be configured to allow the user to select to download the calibration results in bulk or individually.

As mentioned above, in some embodiments, the calibration for each selected imaging device at block 610 of FIG. 6 can include calibrating each selected imaging device to facilitate mapping a 3D location of each corner of an object supported by a conveyor 116, 204 (e.g., objects 118, 208) or supported by a support platform 316 (e.g., object 218) to a 2D location in an image captured by the imaging device. In some embodiments, a factory calibration process may be performed for each imaging device in the machine vision system before installation in the field. FIG. 12A shows an example of a factory calibration setup that can be used to find a transformation between an image coordinate space and a calibration target coordinate space. As shown in FIG. 12A, an imaging device can generate images that project points in a 3D factory coordinate space (Xf, Yf, Zf) onto a 2D image coordinate space (xi, yi). The 3D factory coordinate space can be defined based on a support structure (which may sometimes be referred to as a fixture) that supports a calibration target used to find the transform between the factory coordinate space and the image coordinate space.

Generally, the overall imaging device (e.g., a camera) calibration goal is to find a transformation between a physical 3D coordinate space (e.g., in mm) and the image 2D coordinate space (e.g., in pixels). The transformation in FIG. 12A illustrates an example for such a transformation using a simple pinhole camera model. The transformation can have other nonlinear components (e.g., to represent lens distortion). The transformation can be split into extrinsic and intrinsic parameters. The extrinsic parameters can depend on the location and orientation of mounting the imaging device(s) with respect to the physical 3D coordinate space. The intrinsic parameters can depend on internal imaging device parameters, such as, e.g., the sensor and lens parameters. The calibration process goal is to find value(s) for these intrinsic and extrinsic parameters. In some embodiments, the calibration process can be split into two parts: one part executed in the factory calibration and another part executed in the field.

The factory calibration may be targeted mainly on finding the intrinsic parameters which do not change based on the mounting of the imaging device in the field. This can simplify the calibration process in the field. In some embodiments, an additional field calibration process may be implemented after installation of the machine vision system, for example, during the 3D field calibration process as described above with respect to FIG. 6 (e.g., the calibration at block 610 of FIG. 6). The field calibration may be targeted mainly on finding extrinsics after mounting the imaging devices in the field which can make the field calibration process during system installation much faster and easier. FIG. 12B shows an example of coordinate spaces associated with various portions of a system for capturing multiple images of each side of an object and assigning symbols to an object in accordance with an embodiment of the technology. As shown in 12B, a common 3D coordinate space (e.g., the common 3D coordinate space shown in FIG. 12B with axes Xt, Yt, Zt) can be defined based on a support structure. For example, in FIG. 12B, a conveyor (e.g., as described above in connection with FIGS. 1A, 1B, and 2A) is used to define the common coordinate space, with an origin at a particular location along the conveyor (e.g., with Yt-0 defined at a particular point along the conveyor, for example at a point defined based on the location of a photo eye as described in U.S. Patent Application Publication No. 2021/0125373, Xt=0 defined at one side of the conveyor, and Zt=0 defined at the surface of the conveyor). As another example, the common coordinate space can be defined based on a stationary support structure (e.g., as described above in connection with FIG. 3). Alternatively, in some embodiments, the common coordinate space can be defined based on a dimensioner used to measure the location of an object.

Additionally, in some embodiments, during a calibration process (e.g., a field calibration process), an object coordinate space (Xb, Yb, Zb) can be defined based on an object being used to perform the calibration (e.g., the calibration target discussed above with respect to FIG. 6). For example, as shown in FIG. 12B, symbols can be placed onto an object, where each symbol is associated with a particular location in object coordinate space.

FIG. 12C shows an example of a process for generating an imaging device model useable to transform coordinates of an object in a 3D coordinate space associated with the system for capturing multiple images of each side of the object into coordinates in a 2D coordinate space associated with the imaging device in accordance with an embodiment of the technology. In some embodiments, an imaging device can be calibrated before being installed in the field (e.g., a factory calibration can be performed). As mentioned above, such a calibration can be targeted mainly on finding the intrinsic parameters which do not change on the mounting of the imaging device in the field which can simplify the calibration process in the field. For example, as shown in FIG. 12C, a factory calibration process can be performed to generate intrinsic parameters that can be used with extrinsic parameters to map points in the 3D factory coordinate space into 2D points in the image coordinate space. The intrinsic parameters can represent parameters that relate pixels of the image sensor of an imaging device to an image plane of the imaging device, such as a focal length, an image sensor format, and a principal point. The extrinsic parameters can represent parameters that relate points in 3D common coordinates (e.g., with an origin defined by a target used during factory calibration) to 3D camera coordinates (e.g., with a camera center defined as an origin).

A dimensioner can measure a calibration target (e.g., a box with codes affixed that define a position of each code in the object coordinate space) in the common coordinate space, and the location in common coordinate space can be correlated with locations in image coordinate space of the calibration object (e.g., relating coordinates in (Xt, Yt, Zt) to (xi, yi)). Such correspondence can be used to update the camera model to account for the transformation between the factory coordinate space and the common coordinate space (e.g., by deriving a field calibration extrinsic parameter matrix, which can be defined using a 3D rigid transformation relating one 3D coordinate space such as the common coordinate space to another, such as the factory coordinate space). The field calibration extrinsic parameter matrix can be used in conjunction with the camera model derived during factory calibration to relate points in the common coordinate space (Xt, Yt, Zt) to points in image coordinate space (xi, yi). This transformation can be used to map 3D points of an object measured by a dimensioner to an image of the object, such that the portions of the image corresponding to a particular surface can be determined without analyzing the content of the image. Note that the model depicted in FIGS. 12A, 12B, and 12C is a simplified (e.g., pinhole camera) model that can be used to correct for distortion caused by projection to avoid overcomplicating the description, and more sophisticated models (e.g., including lens distortion) can be used in connection with mechanisms described herein.

Note that this is merely an example, and other techniques can be used to define a transformation between common coordinate space and image coordinate space. For example, rather than performing a factory calibration and a field calibration, a field calibration can be used to derive a model relating common coordinates to image coordinates. However, this may cause replacement of an imaging device to be more cumbersome, as the entire calibration may need to be performed to use a new imaging device. In some embodiments, calibrating an imaging device using a calibration target to find a transformation between a 3D factory coordinate space and image coordinates, and calibrating the imaging device in the field to find a transformation that facilitates mapping between common coordinates (e.g., associated with a conveyor, a support platform, or a dimensioner) can facilitate replacement of an imaging device without repeating the field calibration (e.g., as described in U.S. Pat. No. 9,305,231, issued Apr. 5, 2016, which is hereby incorporated by reference herein in its entirety.

FIGS. 13A and 13B show examples of correspondence between coordinates of an object in the 3D coordinate space associated with the system for capturing multiple images of each side of the object and coordinates of the object in the 2D coordinate space associated with the imaging device. As shown in FIG. 13A, mechanisms described herein can map 3D points associated with an object (e.g., the corners of the object) defined in a common coordinate space specified based on geometry of a conveyor to points in an image coordinate space based on a model generated based on a factory calibration and a field calibration. In some embodiments, the 2D points of each corner in image space can be used with knowledge of the orientation of the imaging device to associate each pixel in the image with a particular surface (or side) of an object (or determine that a pixel is not associated with the object) without analyzing the content of the image.

For example, as shown in FIG. 13A, the imaging device is configured to capture images from a front-top angle with respect to the common coordinates. In such an example, 2D locations of the corners of the box can be used to automatically associate a first portion of the image with a “left” side of the box, a second portion with a “front” side of the box, and a third portion with a “top” side of the box. As shown in FIG. 13A, only two of the corners are located within the image, with the other 6 corners falling outside the image. Based on the knowledge that the imaging device is configured to capture images from above the object and/or based on camera calibration (e.g., which facilitates a determination of the location of the imaging device and the optical axis of the imaging device with respect to the common coordinates), the system can determine that the leading left bottom corner and leading left top corner are both visible in the image.

As shown in FIG. 13B, in a second image captured after the box moved a distance ΔYt along the conveyor. As described above, an encoder can be used to determine a distance that the box has traveled between when the first image shown in FIG. 13A was captured and when the second image was captured. Operation of such an encoder is described in U.S. Pat. No. 9,305,231, and U.S. Patent Application Publication No. 2021/0125373, filed Oct. 26, 2020, which is hereby incorporated herein by reference in its entirety. The distance traveled and the 3D coordinates can be used to determine the 2D points in the second image corresponding to corners of the box. Based on the knowledge that the imaging device is configured to capture images from above the object, the system can determine that the trailing top right corner is visible in the image, but the trailing bottom right corner is obstructed by the top of the box. In addition, the top surface of the box is visible but the back and the right surfaces are not visible.

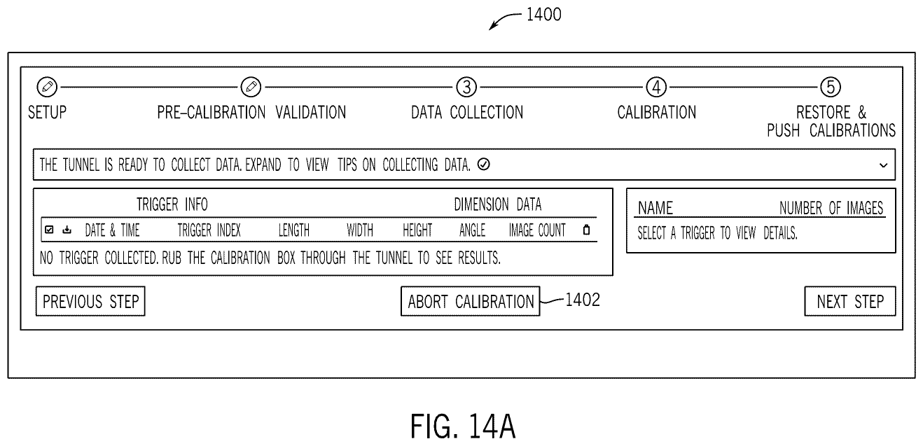

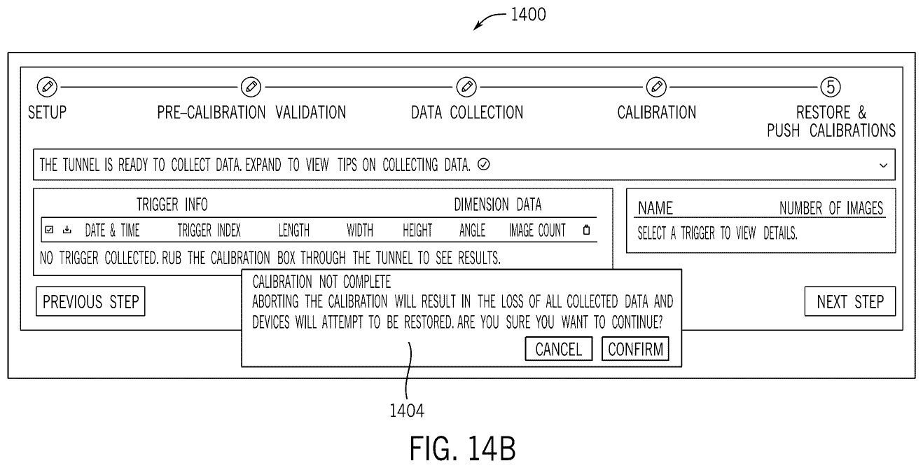

As discussed above, the 3D field calibration application 508 may be configured to generate a data collection user interface, for example, as shown in FIGS. 9A and 9B, that allows a user to select and display triggers for data collection from the selected imaging device(s) 404. In some embodiments, the data collection user interface may also include an “Abort Calibration” option and input to allow a user to stop the calibration process. FIGS. 14A and 14B illustrate an example user interface with an abort calibration option in accordance with an embodiment of the technology. In FIG. 14A, a user interface 1400 (e.g., a data collection user interface 900) may include an input such as, for example, a button 1402, that a user may select to initiate an “abort calibration” process. When a user selects the “abort calibration” input 1402, a prompt such as, for example a confirmation dialog box 1404 (shown in FIG. 14B) may be displayed to confirm whether the user wishes to proceed with halting the calibration process. If the user confirms the “abort calibration” process, then the selected imaging device(s) may be restored (e.g., automatically) to the customer system settings and a finalization user interface (an example of which is shown in FIG. 11) may be displayed that can indicate that the imaging device(s) have been restored to the customer system settings and that the calibration was aborted and that no calibration data has been pushed to the imaging devices. If the user does not wish to proceed with the “abort calibration process”, the user may select to cancel the “abort calibration process” using, for example, a “cancel” input on the prompt 1404. In some embodiments, when the user selects “cancel”, the 3D field calibration application 508 may preserve the user where they are at in the calibration process with no changes made.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above-described steps of the processes of FIG. 6 can be executed or performed in any order or sequence not limited to the order and sequence shown and described in the figures. Also, some of the above steps of the processes of FIG. 6 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for three-dimensional (3D) field calibration of a machine vision system comprising:
receiving a set of calibration parameters and an identification of at least one imaging device of the machine vision system;
determining a camera acquisition parameter for calibration based on the set of calibration parameters;
validating the set of calibration parameters and the camera acquisition parameter;
controlling the at least one imaging device to collect image data of a calibration target, wherein the image data is collected using the determined camera acquisition parameter;
generating a set of calibration data for the at least one imaging device using the collected image data, wherein the set of calibration data includes a maximum error; and
generating a report including the set of calibration data for the at least one imaging device and an indication of whether the maximum error for the at least one imaging device is within an acceptable tolerance.

2. The method according to claim 1, further comprising displaying the report using a display.

3. The method according to claim 1, wherein the machine vision system is configured as a tunnel comprising one imaging device.

4. The method according to claim 1, wherein the machine vision system is configured as a tunnel comprising a plurality of imaging devices.

5. The method according to claim 1, wherein the set of calibration data includes one or more of a runtime conveyor speed, a calibration conveyor speed, a connection address associated with the at least one imaging device, a type of calibration target, or a dimension for the calibration target.

6. The method according to claim 1, further comprising before controlling the at least one imaging device to collect image data of a calibration target, storing, a set of customer system settings for the at least one imaging device.

7. The method according to claim 1, further comprising loading the set of calibration data on the at least one imaging device.

8. The method according to claim 1, wherein generating an indication of whether the maximum error is within an acceptable tolerance includes comparing the maximum error to a predetermined error threshold.

9. The method according to claim 1, wherein the report further includes an image generated based on the collected image data.

10. The method according to claim 1, wherein the calibration target comprises a symbol and the maximum error is a difference between an actual symbol center location and a calculated symbol center location.

11. A system for three-dimensional (3D) field calibration of a machine vision system comprising:
an input configured to receive a set of calibration parameters and an identification of at least one imaging device of the machine vision system; and
at least one processor device coupled to the input, the at least one processor device configured to:
determine a camera acquisition parameter for calibration based on the set of calibration parameters;
validate the set of calibration parameters and the camera acquisition parameter;
control the at least one imaging device to collect image data of a calibration target, wherein the image data is collected using the determined camera acquisition parameter;
generate a set of calibration data for the at least one imaging device using the collected image data, wherein the set of calibration data includes a maximum error; and
generate a report including the set of calibration data for the at least one imaging device and an indication of whether the maximum error for the at least one imaging device is within an acceptable tolerance.

12. The system according to claim 11, further comprising a display coupled to the at least one processor device and configured to display the report.

13. The system according to claim 11, wherein the set of calibration data includes one or more of a runtime conveyor speed, a calibration conveyor speed, a connection address associated with the at least one imaging device, a type of calibration target, or a dimension for the calibration target.

14. The system according to claim 11, wherein the at least one processor device is further configured to, before controlling the at least one imaging device to collect image data of a calibration target, store a set of customer system settings for the at least one imaging device.

15. The system according to claim 11, wherein the at least one processor device is further configured to generate a graphical user interface.

16. The system according to claim 11, wherein generating an indication of whether the maximum error for the at least one imaging device is within an acceptable tolerance includes comparing the maximum error to a predetermined error threshold.

17. The system according to claim 11, wherein the machine vision system is configured as a tunnel comprising one imaging device.

18. The system according to claim 11, wherein the machine vision system is configured as a tunnel comprising a plurality of imaging devices.

19. The system according to claim 11, wherein the report further includes an image generated based on the collected image data.

20. The system according to claim 11, wherein the calibration target comprises a symbol and the maximum error is a difference between an actual symbol center location and a calculated symbol center location.
